(19) United States
(12) Patent Application Publication
(10) Pub. No.: US 2026/0101381 A1
(43) Pub. Date: Apr. 9, 2026

(54) METHOD FOR PERFORMING RANDOM ACCESS PROCEDURE IN WIRELESS COMMUNICATION SYSTEM AND APPARATUS THEREFOR

(71) Applicant: LG ELECTRONICS INC., Seoul (KR)

(72) Inventors: Jaehyung KIM, Seoul (KR); Suckchel YANG, Seoul (KR); Seonwook KIM, Seoul (KR); Youngdae LEE, Seoul (KR); Seungjin AHN, Seoul (KR)

(21) Appl. No.: 19/115,550

(22) PCT Filed: Sep. 19, 2023
(86) PCT No.: PCT/KR2023/014207

§ 371 Date: Mar. 26, 2025

Related U.S. Application Data
(60) Provisional application No. 63/411,607, filed on Sep. 29, 2022.

(51) Int. Cl. H04W 74/0833; H04W 72/21

(52) U.S. Cl. CPC H04W 74/0833; H04W 72/21

(57) ABSTRACT

A method performed by a user equipment (UE) includes transmitting, to a base station, MSG1 related to a random access procedure, receiving a random access response (RAR) from the base station, and transmitting, to the base station, MSG3 scheduled based on an uplink (UL) grant related to the RAR.

### CROSS-REFERENCE TO RELATED APPLICATIONS

This application is the National Stage filing under 35 U.S.C. 371 of International Application No. PCT/KR2023/014207, filed on Sep. 19, 2023, which claims the benefit of U.S. provisional Application No. 63/411,607, filed on Sep. 29, 2022, the contents of which are all hereby incorporated by reference herein in their entirety.

### TECHNICAL FIELD

The present disclosure relates to a method and device for performing a random access procedure in a wireless communication system.

### BACKGROUND

Mobile communication systems have been developed to provide a voice service while ensuring the activity of a user. However, in the mobile communication system, not only a voice, but also a data service is extended. At present, there is a shortage of resources due to an explosive increase in traffic, and users demand a higher speed service. As a result, a more advanced mobile communication system is required.

Requirements for a next-generation mobile communication system should be able to support the acceptance of explosive data traffic, a dramatic increase in the per-user data rate, the acceptance of a significant increase in the number of connected devices, very low end-to-end latency, and high-energy efficiency. To this end, various technologies are researched, which include dual connectivity, massive multiple input multiple output (MIMO), in-band full duplex, non-orthogonal multiple access (NOMA), super wideband support, device networking, and the like.

An NR enhanced Reduced Capability (eRedCap) UE featuring a further reduced maximum UE bandwidth (e.g., 5 MHz) will be introduced in Rel-18.

Compared to a RedCap UE of existing Rel-17, an eRedCap UE introduced in the Rel-18 can process a bandwidth (BW) of up to 5 MHz in a shared channel (PDSCH/PUSCH). However, the eRedCap UE can process a bandwidth of up to 20 MHz in a physical signal and a control channel (PDCCH/PUCCH). In addition, the eRedCap UE allows scheduling for a bandwidth larger than 5 MHz BW only for some broadcast PDSCHs during an initial access process. In this instance, the eRedCap UE cannot process the corresponding PDSCH in the same slot as the RedCap UE of the existing Rel-17.

### DISCLOSURE

### Technical Problem

According to an existing method, a RedCap UE can be early identified by a base station through an early indication. However, the existing method does not define any method for early identification of an eRedCap UE with a different performance from the RedCap UE.

In order to perform a scheduling suitable for the performance of the eRedCap UE, both the RedCap UE and the eRedCap UE need to be identified early.

An object of the present disclosure is to provide a method for an early identification of an eRedCap UE.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

A method performed by a user equipment (UE) in a wireless communication system according to an embodiment of the present disclosure comprises transmitting, to a base station, MSG1 related to a random access procedure, receiving, from the base station, a random access response (RAR), and transmitting, to the base station, MSG3 scheduled based on an uplink (UL) grant related to the RAR.

The UE is a second reduced capability (RedCap) UE with a different capability from a first reduced capability (RedCap) UE.

The second RedCap UE is identified based on the MSG1 and/or the MSG3. The MSG1 is transmitted based on a random access configuration.

The random access configuration is i) a first random access configuration related to the first RedCap UE or ii) a second random access configuration related to the second RedCap UE. The MSG3 is transmitted based on a logical channel ID (LCID) related to the second RedCap UE.

The second RedCap UE may be identified by the MSG3 transmitted based on the LCID.

The method may further comprise receiving a system information block (SIB).

The SIB may include bandwidth part (BWP) configuration information. The BWP configuration information may be related to i) a first initial uplink bandwidth part (UL BWP) for the first RedCap UE or ii) a second initial UL BWP for the second RedCap UE.

The BWP configuration information may include i) the first random access configuration and/or ii) the second random access configuration.

Based on the second random access configuration being absent in the BWP configuration information, the MSG1 may be transmitted based on the first random access configuration.

The RAR may be received based on a maximum bandwidth supported by the first RedCap UE.

Information related to a maximum bandwidth and/or a maximum data transfer rate supported by the second RedCap UE may be indicated based on the MSG3.

Based on the BWP configuration information including the second random access configuration, the second RedCap UE may be identified by the MSG1 transmitted based on the second random access configuration.

The LCID may be different from a dedicated LCID for the first RedCap UE.

The LCID may be an LCID for a non-reduced capability (non-RedCap) UE or a dedicated LCID for the second RedCap UE.

Based on a transmission of the MSG1 based on an initial uplink bandwidth part (UL BWP) consecutively failing a configured number of times, the MSG1 may be transmitted based on other initial UL BWP.

The other initial UL BWP may be i) a first initial UL BWP for the first RedCap UE, ii) a second initial UL BWP for the second RedCap UE, or iii) a third initial UL BWP for a non-RedCap UE.

Based on the initial UL BWP being the second initial UL BWP, the other initial UL BWP may be the first initial UL BWP.

Based on the initial UL BWP being the first initial UL BWP, the other initial UL BWP may be the third initial UL BWP.

Based on the initial UL BWP being the third initial UL BWP, the other initial UL BWP may be the second initial UL BWP.

The MSG1 may be transmitted based on a random access channel occasion (RO), and the RO may be based on a configuration of an active UL BWP in which the random access procedure is triggered.

Based on a configuration related to the RO being absent in the configuration of the active UL BWP: the active UL BWP may be changed to an initial UL BWP, and the RO may be based on a configuration of the initial UL BWP.

The initial UL BWP may be i) a first initial UL BWP for the first RedCap UE, ii) a second initial UL BWP for the second RedCap UE, or iii) a third initial UL BWP for a non-RedCap UE.

A user equipment (UE) operating in a wireless communication system according to another embodiment of the present disclosure comprises one or more transceivers, one or more processors, and one or more memories operably connectable to the one or more processors and storing instructions that configure the one or more processors to perform operations based on being executed by the one or more processors.

The operations comprise transmitting, to a base station, MSG1 related to a random access procedure, receiving, from the base station, a random access response (RAR), and transmitting, to the base station, MSG3 scheduled based on an uplink (UL) grant related to the RAR.

The UE is a second reduced capability (RedCap) UE with a different capability from a first reduced capability (RedCap) UE.

The second RedCap UE is identified based on the MSG1 and/or the MSG3. The MSG1 is transmitted based on a random access configuration.

The random access configuration is i) a first random access configuration related to the first RedCap UE or ii) a second random access configuration related to the second RedCap UE. The MSG3 is transmitted based on a logical channel ID (LCID) related to the second RedCap UE.

A device according to another embodiment of the present disclosure comprises one or more memories and one or more processors operably connected to the one or more memories.

The one or more memories include instructions that configure the one or more processors to perform operations based on being executed by the one or more processors.

The operations comprise transmitting, to a base station, MSG1 related to a random access procedure, receiving, from the base station, a random access response (RAR), and transmitting, to the base station, MSG3 scheduled based on an uplink (UL) grant related to the RAR.

The UE is a second reduced capability (RedCap) UE with a different capability from a first reduced capability (RedCap) UE.

The second RedCap UE is identified based on the MSG1 and/or the MSG3. The MSG1 is transmitted based on a random access configuration.

The random access configuration is i) a first random access configuration related to the first RedCap UE or ii) a second random access configuration related to the second RedCap UE. The MSG3 is transmitted based on a logical channel ID (LCID) related to the second RedCap UE.

One or more non-transitory computer readable mediums according to another embodiment of the present disclosure store one or more instructions.

The one or more instructions executable by one or more processors configure the one or more processors to perform operations.

The operations comprise transmitting, to a base station, MSG1 related to a random access procedure, receiving, from the base station, a random access response (RAR), and transmitting, to the base station, MSG3 scheduled based on an uplink (UL) grant related to the RAR.

The UE is a second reduced capability (RedCap) UE with a different capability from a first reduced capability (RedCap) UE.

The second RedCap UE is identified based on the MSG1 and/or the MSG3. The MSG1 is transmitted based on a random access configuration.

The random access configuration is i) a first random access configuration related to the first RedCap UE or ii) a second random access configuration related to the second RedCap UE. The MSG3 is transmitted based on a logical channel ID (LCID) related to the second RedCap UE.

A method performed by a base station in a wireless communication system according to another embodiment of the present disclosure comprises receiving, from a user equipment (UE), MSG1 related to a random access procedure, transmitting, to the UE, a random access response (RAR), and receiving, from the UE, MSG3 scheduled based on an uplink (UL) grant related to the RAR.

The UE is a second reduced capability (RedCap) UE with a different capability from a first reduced capability (RedCap) UE.

The second RedCap UE is identified based on the MSG1 and/or the MSG3. The MSG1 is received based on a random access configuration.

The random access configuration is i) a first random access configuration related to the first RedCap UE or ii) a second random access configuration related to the second RedCap UE.

The MSG3 is received based on a logical channel ID (LCID) related to the second RedCap UE.

A base station operating in a wireless communication system according to another embodiment of the present disclosure comprises one or more transceivers, one or more processors, and one or more memories operably connectable to the one or more processors and storing instructions that configure the one or more processors to perform operations based on being executed by the one or more processors.

The operations comprise receiving, from a user equipment (UE), MSG1 related to a random access procedure, transmitting, to the UE, a random access response (RAR), and receiving, from the UE, MSG3 scheduled based on an uplink (UL) grant related to the RAR.

The UE is a second reduced capability (RedCap) UE with a different capability from a first reduced capability (RedCap) UE.

The second RedCap UE is identified based on the MSG1 and/or the MSG3. The MSG1 is received based on a random access configuration.

The random access configuration is i) a first random access configuration related to the first RedCap UE or ii) a second random access configuration related to the second RedCap UE.

The MSG3 is received based on a logical channel ID (LCID) related to the second RedCap UE.

### Advantageous Effects

According to an embodiment of the present disclosure, an eRedCap UE with a different capability from an existing RedCap UE can be early identified.

Accordingly, a scheduling suitable for the capability of the eRedCap UE can be performed. For example, if it is early identified that a UE is an eRedCap UE through MSG1, an RAR (PDCCH, PDSCH) can be transmitted based on a bandwidth suitable for a capability of the eRedCap UE.

As a new type of UE (i.e., eRedCap UE) is introduced, an influence on existing UEs (non-RedCap UE, RedCap UE) can be minimized.

Since scheduling for an eRedCap UE can be performed based on a bandwidth less than a bandwidth supported by other UEs, efficiency of resource allocation and network management can be further improved compared to when the eRedCap UE is not early identified.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### BRIEF DESCRIPTION OF THE DRAWINGS

FIG. 1 illustrates physical channels and general signal transmission used in a 3GPP system.

FIG. 2 is a diagram illustrating an SSB structure to which a method proposed in the present disclosure is applicable.

FIG. 3 illustrates SSB transmission to which a method proposed in the present disclosure is applicable.

FIG. 4 illustrate a random access procedure to which a method proposed in the present disclosure is applicable.

FIG. 5 is a flow chart illustrating a method performed by a user equipment according to an embodiment of the present disclosure.

FIG. 6 is a flow chart illustrating a method performed by a base station according to another embodiment of the present disclosure.

FIG. 7 illustrates configuration of a first device and a second device according to an embodiment of the present disclosure.

### DETAILED DESCRIPTION

Hereinafter, downlink (DL) means communication from the base station to the terminal and uplink (UL) means communication from the terminal to the base station. In downlink, a transmitter may be part of the base station, and a receiver may be part of the terminal. In uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

The following technology may be used in various radio access system including CDMA, FDMA, TDMA, OFDMA, SC-FDMA, and the like. The CDMA may be implemented as radio technology such as Universal Terrestrial Radio Access (UTRA) or CDMA2000. The TDMA may be implemented as radio technology such as a global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802.20, Evolved UTRA (E-UTRA), or the like. The UTRA is a part of Universal Mobile Telecommunications System (UMTS). 3rd Generation Partnership Project (3GPP) Long Term Evolution (LTE) is a part of Evolved UMTS (E-UMTS) using the E-UTRA and LTE-Advanced (A)/LTE-A pro is an evolved version of the 3GPP LTE. 3GPP NR (New Radio or New Radio Access Technology) is an evolved version of the 3GPP LTE/LTE-A/LTE-A pro.

For clarity of description, the technical spirit of the present disclosure is described based on the 3GPP communication system (e.g., LTE-A or NR), but the technical spirit of the disclosure is not limited thereto. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a detailed standard document number. The LTE/NR may be collectively referred to as the 3GPP system.

Matters disclosed in a standard document opened before the disclosure may be referred to for a background art, terms, omissions, etc., used for describing the disclosure. For example, the following documents may be referred to.

### 3GPP NR

3GPP TS 38.211: Physical channels and modulation
3GPP TS 38.212: Multiplexing and channel coding
3GPP TS 38.213: Physical layer procedures for control
3GPP TS 38.214: Physical layer procedures for data
3GPP TS 38.215: Physical layer measurements
3GPP TS 38.300: NR and NG-RAN Overall Description
3GPP TS 38.304: User Equipment (UE) procedures in idle mode and in RRC inactive state
3GPP TS 38.321: Medium Access Control (MAC) protocol
3GPP TS 38.322: Radio Link Control (RLC) protocol
3GPP TS 38.323: Packet Data Convergence Protocol (PDCP)
3GPP TS 38.331: Radio Resource Control (RRC) protocol
3GPP TS 37.324: Service Data Adaptation Protocol (SDAP)
3GPP TS 37.340: Multi-connectivity; Overall description
3GPP TS 23.287: Application layer support for V2X services; Functional architecture and information flows
3GPP TS 23.501: System Architecture for the 5G System
3GPP TS 23.502: Procedures for the 5G System
3GPP TS 23.503: Policy and Charging Control Framework for the 5G System; Stage 2
3GPP TS 24.501: Non-Access-Stratum (NAS) protocol for 5G System (5GS); Stage 3
3GPP TS 24.502: Access to the 3GPP 5G Core Network (5GCN) via non-3GPP access networks
3GPP TS 24.526: User Equipment (UE) policies for 5G System (5GS); Stage 3

As more and more communication devices require larger communication capacity, there is a need for improved mobile broadband communication compared to the existing radio access technology (RAT). Further, massive machine type communications (MTCs), which provide various services anytime and anywhere by connecting many devices and objects, are one of the major issues to be considered in the next generation communication. In addition, a communication system design considering a service/UE sensitive to reliability and latency is being discussed. The introduction of next generation radio access technology considering enhanced mobile broadband communication (eMBB), massive MTC (mMTC), ultra-reliable and low latency communication (URLLC) is discussed, and in the disclosure, the technology is called new RAT for convenience. The NR is an expression representing an example of 5G radio access technology (RAT).

In a new RAT system including NR uses an OFDM transmission scheme or a similar transmission scheme thereto. The new RAT system may follow OFDM parameters different from OFDM parameters of LTE. Alternatively, the new RAT system may follow numerology of conventional LTE/LTE-A as it is or have a larger system bandwidth (e.g., 100 MHz). Alternatively, one cell may support a plurality of numerologies. In other words, UEs that operate with different numerologies may coexist in one cell.

The numerology corresponds to one subcarrier spacing in a frequency domain. Different numerologies may be defined by scaling reference subcarrier spacing to an integer N.

### Bandwidth Part (BWP)

In the NR system, up to 400 MHz can be supported per one carrier. If a UE operating in such a wideband carrier is always operated with a radio frequency (RF) module for all carriers turned on, battery consumption by the UE may increase. Alternatively, considering several use cases (e.g., eMBB, URLLC, mMTC, V2X, etc.) that are operated in one wideband carrier, different numerologies (e.g., subcarrier spacing) may be supported for each frequency band in the corresponding carrier. Alternatively, a capability for a maximum bandwidth may be different for each UE. Considering this, a base station (BS) may indicate the UE to operate only in a partial bandwidths rather than the entire bandwidth of a wideband carrier, and the partial bandwidth is defined as a bandwidth part (BWP). The BWP in the frequency doamin is a subset of continuous common resource blocks defined for numerology μi within a bandwidth part i on the carrier, and one numerology (e.g., subcarrier spacing, CP length, slot/mini-slot duration) may be configured.

The BS may configure one or more BWPs within one carrier configured for the UE. Alternatively, if UEs are concentrated on a specific BWP, some UEs may be shifted to different BWPs for load balancing. Alternatively, both BWPs may be configured in the same slot excluding some center spectrums of the entire bandwidth considering frequency domain inter-cell interference cancellation between contiguous cells, etc. That is, the BS can configure at least one DL/UL BWP to a UE associated with the wideband carrier, can activate at least one DL/UL BWP of configured DL/UL BWP(s) at a specific time (by L1 signaling which is the physical layer control signal, MAC control element (CE) which is the MAC layer control signal, or RRC signaling, etc.) and indicate to switch to other configured DL/UL BWP (by L1 signaling, MAC CE, or RRC signaling, etc.), or can the UE to switch to a given DL/UL BWP if a timer value is set and a timer is expired. The activated DL/UL BWP is defined as an active DL/UL BWP. The UE may not receive configuration for the DL/UL BWP when the UE is in an initial access procedure or RRC connection of the UE is not set up yet. In this situation, a DL/UL BWP assumed by the UE is defined as an initial active DL/UL BWP.

### Physical Channel and General Signal Transmission

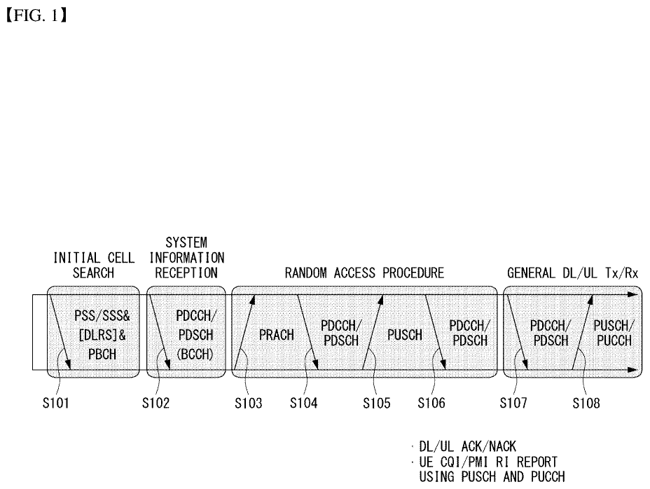

FIG. 1 illustrates physical channels and general signal transmission used in 3GPP systems. In a wireless communication system, the UE receives information from the eNB through downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S101). To this end, the UE may receive a primary synchronization signal (PSS) and a (secondary synchronization signal (SSS) from the eNB and synchronize with the eNB and acquire information such as a cell ID or the like. Thereafter, the UE may receive a physical broadcast channel (PBCH) from the eNB and acquire in-cell broadcast information. The UE receives a downlink reference signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S102).

When there is no radio resource first accessing the eNB or for signal transmission, the UE may perform a Random Access Procedure (RACH) to the eNB (S103 to S106). To this end, the UE may transmit a specific sequence to a preamble through a Physical Random Access Channel (PRACH) (S103 and S105) and receive a response message (Random Access Response (RAR) message) for the preamble through the PDCCH and a corresponding PDSCH. In the case of a contention based RACH, a Contention Resolution Procedure may be additionally performed (S106).

The UE that performs the above procedure may then perform PDCCH/PDSCH reception (S107) and Physical Uplink Shared Channel (PUSCH)/Physical Uplink Control Channel (PUCCH) transmission (S108) as a general uplink/downlink signal transmission procedure. In particular, the UE may receive Downlink Control Information (DCI) through the PDCCH.

The UE monitors a set of PDCCH candidates in monitoring occasions configured to one or more control element sets (CORESETs) on a serving cell based on corresponding search space configurations. The set of PDCCH candidates to be monitored by the UE is defined in terms of search space sets, and the search space set may be a common search space set or a UE-specific search space set. The CORESET consists of a set of (physical) resource blocks with a duration of one to three OFDM symbols. A network may configure the UE to have a plurality of CORESETs. The UE monitors PDCCH candidates in one or more search space sets. Here, the monitoring means attempting to decode PDCCH candidate(s) in a search space. If the UE succeeds in decoding one of the PDCCH candidates in a search space, the UE determines that a PDCCH has been detected from the PDCCH candidates and performs PDSCH reception or PUSCH transmission based on DCI within the detected PDCCH.

The PDCCH may be used to schedule DL transmissions on PDSCH and UL transmissions on PUSCH. The DCI on the PDCCH includes downlink assignment (i.e., DL grant) related to a downlink shared channel and including at least a modulation and coding format and resource allocation information, or an uplink grant (UL grant) related to an uplink shared channel and including a modulation and coding format and resource allocation information. The DCI has different formats depending on its purpose.

The control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

Initial Access (IA) and Random Access (RA) procedure

### Synchronization Signal Block (SSB) Transmission and Related Operation

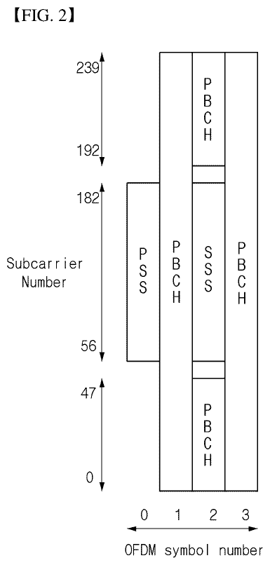

FIG. 2 is a diagram illustrating an SSB structure to which a method proposed in the present disclosure is applicable. The UE may perform cell search, system information acquisition, beam alignment for initial access, DL measurement, and the like based on an SSB. The SSB is interchangeably used with a synchronization signal/physical broadcast channel (SS/PBCH) block.

Referring to FIG. 2, the SSB includes a PSS, an SSS and a PBCH. The SSB consists of four consecutive OFDM symbols, and the PSS, the PBCH, the SSS/PBCH or the PBCH is transmitted per OFDM symbol. Each of the PSS and the SSS consists of one OFDM symbol and 127 subcarriers, and the PBCH consists of 3 OFDM symbols and 576 subcarriers.

Polar coding and quadrature phase shift keying (QPSK) are applied to the PBCH. The PBCH consists of data REs and demodulation reference signal (DMRS) REs every OFDM symbol. Three DMRS REs are present per RB, and three data REs are present between the DMRS REs.

FIG. 3 illustrates SSB transmission to which a method proposed in the present disclosure is applicable.

The SSB is periodically transmitted in accordance with SSB periodicity. A default SSB periodicity assumed by a UE during initial cell search is defined as 20 ms. After cell access, the SSB periodicity may be set to one of {5 ms, 10 ms, 20 ms, 40 ms, 80 ms, 160 ms} by a network (e.g., a BS). An SSB burst set is configured at a beginning part of the SSB periodicity. The SSB burst set includes a 5 ms time window (i.e., half-frame), and the SSB may be transmitted up to N times within the SSB burst set. The maximum transmission number L of the SSB may be given as follows according to a frequency band of a carrier. One slot includes up to two SSBs.
For frequency range up to 3 GHZ, L=4
For frequency range from 3 GHz to 6 GHZ, L=8
For frequency range from 6 GHz to 52.6 GHz, L=64

A time location of SSB candidates within the SSB burst set may be defined depending on SCS as follows. The time location of the SSB candidates is indexed (SSB index) from 0 to L−1 based on time order within the SSB burst set (i.e., half-frame).

A plurality of SSBs may be transmitted within a frequency span of a carrier. Physical layer cell identifiers of these SSBs need not be unique, and other SSBs may have other physical layer cell identifiers.

The UE may acquire DL synchronization by detecting the SSB. The UE can identify a structure of the SSB burst set based on the detected SSB (time) index, and thus can detect a symbol/slot/half-frame boundary. The number of the frame/half-frame to which the detected SSB belongs may be identified using system frame number (SFN) information and half-frame indication information.

### Random Access Procedure

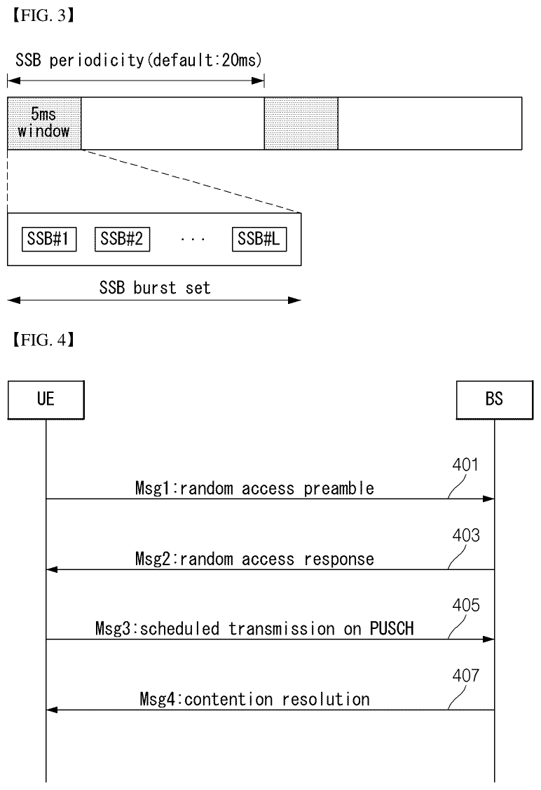

A random access procedure of a UE may be summarized as shown in Table 1 and FIG. 4.

TABLE 1

| | Type of Signals | Operations/Information obtained |
|---|---|---|
| 1^{st} step | PRACH preamble in UL | Initial beam obtainment |
| | | Random selection of RA-preamble ID |
| 2^{nd} step | Random Access Response on DL-SCH | Timing Advanced information |
| | | RA-preamble ID |
| | | Initial UL grant, Temporary C-RNTI |
| 3^{rd} step | UL transmission on UL-SCH | RRC connection request |
| | | UE identifier |
| 4^{th} step | Contention Resolution on DL | Temporary C-RNTI on PDCCH for initial access |
| | | C-RNTI on PDCCH for UE in RRC_CONNECTED |

The UE may acquire UL synchronization and UL transmission resources through the random access procedure. The random access procedure is classified into a contention-based random access procedure and a contention-free random access procedure.

FIG. 4 illustrate a random access procedure to which a method proposed in the present disclosure is applicable. This is described in detail below.

First, a UE may transmit a random access preamble on a PRACH as Msg1 of a random access procedure in UL (e.g., see, 401 of FIG. 4).

Random access preamble sequences having different two lengths are supported. Long sequence length 839 is applied to subcarrier spacings of 1.25 kHz and 5 kHz, and short sequence length 139 is applied to subcarrier spacings of 15 kHz, 30 kHz, 60 kHz and 120 KHz.

Multiple preamble formats are defined by one or more RACH OFDM symbols and different cyclic prefixes (and/or guard time). RACH configuration for a cell is included in system information of the cell and is provided to the UE. The RACH configuration includes information on a subcarrier spacing of PRACH, available preambles, preamble format, and the like. The RACH configuration includes association information between SSBs and RACH (time-frequency) resources. The UE transmits a random access preamble in the RACH time-frequency resource associated with the detected or selected SSB.

A threshold of the SSB for the RACH resource association may be set by the network, and an RACH preamble is transmitted or retransmitted based on the SSB in which reference signal received power (RSRP) measured based on the SSB satisfies the threshold. For example, the UE may select one of the SSB(s) satisfying the threshold and may transmit or retransmit the RACH preamble based on the RACH resource associated with the selected SSB.

When a BS receives the random access preamble from the UE, the BS transmits a random access response (RAR) message (Msg2) to the UE (e.g., see 403 of FIG. 4). A PDCCH that schedules a PDSCH carrying a RAR is CRC masked with a random access (RA) radio network temporary identifier (RNTI) (RA-RNTI) and is transmitted. The UE that detects the PDCCH masked with the RA-RNTI may receive a RAR from the PDSCH scheduled by DCI carried by the PDCCH. The UE checks whether the RAR includes random access response information for the preamble transmitted by the UE, i.e., Msg1. Presence or absence of random access information for the Msg1 transmitted by the UE may be determined based on presence or absence of a random access preamble ID for the preamble transmitted by the UE. If there is no response to the Msg1, the UE may retransmit the RACH preamble less than a predetermined number of times while performing power ramping. The UE calculates PRACH transmission power for preamble retransmission based on most recent pathloss and a power ramping counter.

The random access response information includes timing advance information for UL synchronization, an UL grant, and UE temporary cell RNTI (C-RNTI). If a temporary UE receives random access response information for the UE itself on the PDSCH, the UE can know timing advance information for UL synchronization, an initial UL grant, and UE temporary cell RNTI (C-RNTI). The timing advance information is used to control uplink signal transmission timing. In order to ensure that the PUSCH/PUCCH transmission by the UE is better aligned with subframe timing at a network end, the network (e.g. BS) may measure a time difference between the PUSCH/PUCCH/SRS reception and subframes and send timing advance information based on the time difference. The UE may perform UL transmission as Msg3 of the random access procedure on a physical uplink shared channel based on the random access response information (e.g., see 405 of FIG. 4). The Msg3 may include an RRC connection request and a UE identifier. The network may transmit Msg4 as a response to the Msg3, and the Msg4 may be handled as a contention resolution message on DL (e.g., see 407 of FIG. 4). The UE may enter an RRC connected state by receiving the Msg4.

Meanwhile, the contention-free random access procedure may be used or performed when the UE handovers to another cell or the BS or when the contention-free random access procedure is requested by a command of the BS. A basic process of the contention-free random access procedure is similar to the contention-based random access procedure. However, unlike the contention-based random access procedure in which the UE randomly selects a preamble to be used among a plurality of random access preambles, in the contention-free random access procedure, a preamble (hereinafter, referred to as a dedicated random access preamble) to be used by the UE is allocated by the BS to the UE. Information on the dedicated random access preamble may be included in an RRC message (e.g., a handover command) or may be provided to the UE via a PDCCH order. When the random access procedure is initiated, the UE transmits the dedicated random access preamble to the BS. When the UE receives the random access procedure from the BS, the random access procedure is completed.

As mentioned above, the UL grant in the RAR schedules PUSCH transmission to the UE. The PUSCH carrying initial UL transmission based on the UL grant in the RAR is also referred to as Msg3 PUSCH. The content of the RAR UL grant starts at an MSB and ends at a LSB, and is given in Table 2.

TABLE 2

| RAR UL | Number of |
|---|---|
| grant field | bits |
| Frequency hopping flag | 1 |
| Msg3 PUSCH frequency resource | 12 |
| allocation | |
| Msg3 PUSCH time resource allocation | 4 |
| Modulation and coding scheme (MCS) | 4 |
| Transmit power control (TPC) for | 3 |
| Msg3 PUSCH | |
| CSI request | 1 |

In the contention-free random access procedure, a CSI request field in the RAR UL grant indicates whether the UE includes an aperiodic CSI report in the corresponding PUSCH transmission. A subcarrier spacing for the Msg3 PUSCH transmission is provided by an RRC parameter. The UE will transmit the PRACH and Msg3 PUSCH on the same uplink carrier of the same service serving cell. A UL BWP for Msg3 PUSCH transmission is indicated by SIB1 (SystemInformationBlock1).

The contents described above can be combined and applied to methods described below in the present disclosure, or can be supplemented to clarify technical features of the methods described in the present disclosure. Methods described below are merely distinguished for convenience of explanation. Thus, it is obvious that partial configuration of any method can be substituted or combined with partial configuration of another method.

Technical terms used in the present disclosure
UE: User Equipment
SSB: Synchronization Signal Block
MIB: Master Information Block
RMSI: Remaining Minimum System Information
FR1: Frequency domain with frequency range of 1.6 GHz or less (e.g., 450 MHz to 6,000 MHz)
FR2: Millimeter wave (mmWave) domain with frequency range of 2.24 GHz or higher (e.g., 24,250 MHz to 52,600 MHz)
BW: Bandwidth
BWP: Bandwidth Part
RNTI: Radio Network Temporary Identifier
CRC: Cyclic Redundancy Check
SIB: System Information Block
SIB1: SIB1 for NR devices=RMSI (Remaining Minimum System Information). It broadcasts information, etc. necessary for cell access of an NR UE.
CORESET (COntrol REsource SET): Time/frequency resource in which an NR UE tries candidate PDCCH decoding
CORESET #0: CORESET for Type0-PDCCH CSS set for NR devices (configured in MIB)
Type0-PDCCH CSS set: a search space set in which an NR UE monitors a set of PDCCH candidates for a DCI format with CRC scrambled by a SI-RNTI
MO: PDCCH Monitoring Occasion for Type0-PDCCH CSS set
SIB1-R: (additional) SIB1 for reduced capability NR devices. It may be limited when it is generated with a separate TB from SIB1 and is transmitted on a separate PDSCH.
CORESET #0-R: CORESET #0 for reduced capability NR devices
Type0-PDCCH-R CSS set: a search space set in which a redcap UE monitors a set of PDCCH candidates for a DCI format with CRC scrambled by a SI-RNTI
MO-R: PDCCH Monitoring Occasion for Type0-PDCCH CSS set
Cell defining SSB (CD-SSB): SSB including RMSI scheduling information among NR SSBs
Non-cell defining SSB (non-CD-SSB): SSB that has been deployed on NR sync raster, but does not include RMSI scheduling information of a corresponding cell for measurement. But, the SSB may include information informing a location of cell defining SSB.
SCS: subcarrier spacing
SI-RNTI: System Information Radio-Network Temporary Identifier
Camp on: “Camp on” is the UE state in which the UE stays on a cell and is ready to initiate a potential dedicated service or to receive an ongoing broadcast service.
TB: Transport Block
RSA (Redcap standalone): Cell supporting only redcap device or service
SIB1(-R)-PDSCH: PDSCH transmitting SIB1(-R)
SIB1(-R)-DCI: DCI scheduling SIB1(-R)-PDSCH. DCI format 1_0 with CRC scrambled by SI-RNTI.
SIB1(-R)-PDCCH: PDCCH transmitting SIB1(-R)-DCI
FDRA: Frequency Domain Resource Allocation
TDRA: Time Domain Resource Allocation
RA: Random Access
MSGA: preamble and payload transmissions of the random access procedure for 2-step RA type.
MSGB: response to MSGA in the 2-step random access procedure. MSGB may consist of response(s) for contention resolution, fallback indication(s), and backoff indication.
RO-N: RACH Occasion (RO) for normal UE 4-step RACH and 2-step RACH (if configured)
RO-N1, RO-N2: If separate RO is configured for normal UE 2-step RACH, it is divided into RO-N1 (4-step) and RO-N2 (2-step).
RO-R: RACH Occasion (RO) separately configured from RO-N for redcap UE 4-step RACH and 2-step RACH (if configured)
RO-R1, RO-R2: If separate RO is configured for redcap UE 2-step RACH, it is divided into RO-R1 (4-step) and RO-R2 (2-step).
PG-R: MsgA-Preambles Group for redcap UEs
RAR: Random Access Response
RAR window: the time window to monitor RA response(s)
FH: Frequency Hopping
iBWP: initial BWP
iBWP-DL (-UL): initial DL (UL) BWP
iBWP-DL (-UL)-R: (separate) initial DL (UL) BWP for RedCap
CS: Cyclic shift
NB: Narrowband
TO: Traffic Offloading
mMTC; massive Machine Type Communications
eMBB: enhanced Mobile Broadband Communication
URLLC: Ultra-Reliable and Low Latency Communication
RedCap: Reduced Capability
eRedCap: enhanced RedCap
FDD: Frequency Division Duplex
HD-FDD: Half-Duplex-FDD
DRX: Discontinuous Reception
RRC: Radio Resource Control
RRM: Radio Resource Management
IWSN: Industrial Wireless Sensor Network
LPWA: Low Power Wide Area
RB: Resource Block
CCE: Control Channel Element
AL: Aggregation Level
PRG: Physical Resource-block Group
DFT-s-OFDM: DFT-spread OFDM
PBCH: Physical Broadcast Channel
A-PBCH: Additional PBCH
BD: blind detection
EPRE: Energy Per RE
SNR: Signal-to-Noise Ratio
TDM: Time Division Multiplexing
DMRS: DeModulation Reference Signal
TDD: Time Division Duplex
SS: Synchronization Signal
RS: Reference Signal
SIB1-eR: Dedicated SIB1 for eRedCap devices. It can be generated and transmitted in the same TB as SIB1 for non-eRedCap UEs or in a separate TB, and if it is generated in the separate TB, it can be transmitted on a separate PDSCH.
RF: Radio Frequency
BB: BaseBand
OSI: Other System Information

In the present disclosure, ‘( )’ can be interpreted as both when excluding content in parentheses and when including content in parentheses.

In the present disclosure, ‘/’ can be interpreted as when including all the contents separated by ‘/’ (and), or when including only a part of the separated contents (or).

In addition to 5G main use cases (mMTC, eMBB and URLLC), importance/interest in use case areas across mMTC and eMBB, or mMTC and URLLC has been increasing recently. In order to more efficiently support these use cases including connected industries, smart city, wearables, etc. in terms of UE cost/complexity, power consumption, or the like in a wireless communication system, a new type of UE which is distinguished from an existing NR UE has been introduced. The new type of UE is referred to as a Reduced Capability NR UE/terminal or simply a RedCap UE/terminal or RedCap, and the existing NR UE is referred to as a non-RedCap UE/terminal or non-RedCap or general/existing NR UE/terminal, etc. in order to distinguish from the RedCap UE.

The RedCap UE has features that are inexpensive compared to the non-RedCap UE and have small power consumption, and in particular, may have all or some of features based on Table 3 below.

TABLE 3
[RedCap UE features]

| | |
|---|---|
| ● | Complexity reduction features |
| | ▪ Reduced maximum UE Bandwidth |
| | ▪ Reduced number of UE RX/TX branches/antennas |
| | ▪ Half-Duplex-FDD |
| | ▪ Relaxed UE processing time |
| | ▪ Relaxed UE processing capability |
| ● | Power saving |
| | ▪ Extended DRX for RRC Inactive and/or Idle |
| | ▪ RRM relaxation for stationary devices |

Target use cases of the RedCap UE with the above features may be based on Table 4 below.

TABLE 4
[Redcap use cases]

| ● | Connected industries | |
|---|---|---|
| | ▪ | Sensors and actuators are connected to 5G networks and core |
| | ▪ | Include massive IWSN (Industrial Wireless Sensor Network) use |
| | | cases and requirements |
| | ▪ | Not only URLLC services with very high requirements, but also |
| | | relatively low-end services with the requirement of small device form |
| | | factors with a battery life of several years |
| | ▪ | Requirements for these services are higher than LPWA (Low Power |
| | | Wide Area, i.e. LTE-M/NB-IOT) but lower than URLCC and eMBB |
| | ▪ | Devices in such environment include e.g. pressure sensors, humidity |
| | | sensors, thermometers, motion sensors, accelerometers, actuators, etc. |
| ● | Smart city | |
| | ▪ | The smart city vertical covers data collection and processing to more |
| | | efficiently monitor and control city resources, and to provide services to |
| | | city residents |
| | ▪ | Especially, the deployment of surveillance cameras is an essential part |
| | | of the smart city but also of factories and industries |
| ● | Wearables | |
| | ▪ | Wearables use case includes smart watches, rings, eHealth related |
| | | devices, and medical monitoring devices etc. |
| | ▪ | One characteristic for the use case is that the device is small in size |

The background to the introduction of eRedCap UE type for further UE complexity reduction is described in detail below.

In order to support the RedCap use cases mentioned above in 3GPP Rel-17 with low cost/low power, a RedCap UE type which is a new NR-based UE type was introduced. In Rel-18, among the RedCap use cases, it is considered to introduce a RedCap-based (and therefore fundamentally NR-based) UE (type) that is more optimized for RedCap use cases that require lower cost/lower power, such as IWSN and wearables.

The UE (type) being considered for introduction in the Rel-18 is referred to as an enhanced RedCap, abbreviated as an eRedCap UE/terminal, or simply eRedCap. On the contrary, a UE which is not the eRedCap (including the RedCap and non-RedCap UEs) is referred to as a non-eRedCap UE/terminal, or simply a non-eRedCap.

The eRedCap may have features that are distinguished from the existing NR UE/RedCap UE in terms of UE support maximum RF/BB (Base Band) bandwidth, number of Rx branches, reception coverage, etc. If these distinguished features are necessary in a random access procedure for initial access or a step before a connected state, they may be supported through a UE early identification function. A RedCap UE early identification function was introduced for RedCap UE early identification in Rel-17.

The RedCap UE early identification function introduced in the Rel-17 may be supported in Msg1 and Msg3 stages. The early identification function, in which a UE indicates to a base station whether the UE is a RedCap UE using an LCID in the Msg3 stage, may be provided by default. The early identification function, in which a UE indicates whether the UE is a RedCap UE using a separate PRACH resource in the Msg1 stage, may be additionally supported by network configuration.

For example, operations related to the RedCap UE early identification may be based on Table 5 below.

TABLE 5
16.13.3 Identification, access and camping restrictions

```
  A RedCap UE can be identified by the network during Random Access procedure via
MSG3/MSGA from a RedCap specific LCID(s) and optionally via MSG1/MSGA (PRACH
occasion or PRACH preamble). For RedCap UE identification via MSG1/MSGA, RedCap specific
Random Access configuration may be configured by the network. For MSG3/MSGA, a RedCap
UE is identified by the dedicated LCID(s) indicated for CCCH identification (CCCH or CCCH1)
regardless whether RedCap specific Random Access configuration is configured by the network.
  RedCap UEs with 1 Rx branch and 2 Rx branches can be allowed separately via system
information. In addition, RedCap UEs in Half-Duplex FDD mode can be allowed via system
information. A RedCap specific IFRI can be provided in SIB1, when absent, RedCap UEs access is
not allowed. Information on which frequencies RedCap UE access is allowed can be provided in
system information.
  A RedCap UE with 1 Rx branch applies the associated offset for broadcasted cell specific
RSRP thresholds for random access, SDT, cell edge condition and cell (re)selection criterion as
specified in TS 38.133 [13].
NOTE:
It is up to the E-UTRA network, if possible, to avoid handover attempts of a RedCap UE to a target NR cell not supporting RedCap. It is up to the RedCap UE implementation, if possible, to recover from handover attempts to a target NR cell not supporting RedCap.
```

For example, the LCID may be based on definition/configuration of Table 6 below.

TABLE 6
LCID: The Logical Channel ID field identifies the logical
channel instance of the corresponding MAC SDU or the type of the
corresponding MAC CE or padding as described in Tables 6.2.1-1,
6.2.1-1c and 6.2.1-2 for the DL-SCH and UL-SCH respectively.
There is one LCID field per MAC subheader. The size of the
LCID field is 6 bits. If the LCID field is set to 34, one
additional octet is present in the MAC subheader containing
the eLCID field and follow the octet containing LCID field.
If the LCID field is set to 33, two additional octets are
present in the MAC subheader containing the eLCID field and these
two additional octets follow the octet containing LCID field;
Table 6.2.1-2 Values of LCID for UL-SCH

| Codepoint/Index | LCID values |
|---|---|
| 0 | CCCH of size 64 bits (referred to as “CCCH1” in TS 38.331 [5]), except for |
| | a RedCap UE |
| 1-32 | Identity of the logical channel of DCCH and DTCH |
| 33 | Extended logical channel ID field (two-octet eLCID field) |
| 34 | Extended logical channel ID field (one-octet eLCID field) |
| 35 | CCCH of size 48 bits (referred to as “CCCH” in TS 38.331 [5]) for a |
| | RedCap UE |
| 36 | CCCH of size 64 bits (referred to as “CCCH1” in TS 38.331 [5]) for a |
| | RedCap UE |
| 37-42 | Reserved |
| 43 | Truncated Enhanced BFR (one octet Cᵢ) |
| 44 | Timing Advance Report |
| 45 | Truncated Sidelink BSR |
| 46 | Sidelink BSR |
| 47 | Reserved |
| 48 | LBT failure (four octets) |
| 49 | LBT failure (one octet) |
| 50 | BFR (one octet Cᵢ) |
| 51 | Truncated BFR (one octet Cᵢ) |
| 52 | CCCH of size 48 bits (referred to as “CCCH” in TS 38.331 [5]), except for a |
| | RedCap UE |
| 53 | Recommended bit rate query |
| 54 | Multiple Entry PHR (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

For example, the RedCap UE may operate based on Table 7 below.

```
TABLE 7
A UE with reduced capabilities (RedCap UE) supports all Layer-1 UE features that are
mandatory without capability signalling, unless stated otherwise.
17.1 RedCap UE procedures
  Procedures for a RedCap UE are same as described for a UE in all other clauses of this
document unless stated otherwise. In this clause, the term ‘UE’ refers to a RedCap UE.
  A UE expects the initial DL BWP and the active DL BWP after the UE (re)establishes dedicated
RRC connection to be smaller than or equal to the maximum DL bandwidth that the UE supports.
A UE can be provided a DL BWP by initialDownlinkBWP-RedCap in
DownlinkConfigCommonSIB, and an UL BWP by initialUplinkBWP-RedCap in
UplinkConfigCommonSIB. If initialUplinkBWP in UplinkConfigCommonSIB indicates an UL BWP
that is larger than a maximum UL BWP that a UE supports, the UE expects to be provided an UL
BWP by initialUplinkBWP-RedCap in UplinkConfigCommonSIB that is smaller than or equal to
the maximum UL bandwidth that the UE supports.
  For unpaired spectrum operation, a RedCap UE does not expect to receive a configuration where
the center frequency for an initial DL BWP in which the UE is configured to monitor Type1-
PDCCH CSS set is different than the center frequency for an initial UL BWP in which the RedCap
UE may transmit Msg1/Msg3 or MsgA.
  A UE can be provided by BWP-DownlinkDedicated a DL BWP, other than the initial DL BWP.
A UE can be provided by BWP-UplinkDedicated an UL BWP, other than the initial UL BWP, that
is smaller than or equal to the maximum UL bandwidth that the UE supports.
  If a UE is provided an UL BWP by initialUplinkBWP-RedCap in UplinkConfigCommonSIB and
is provided rach-ConfigCommon or msgA-ConfigCommon in BWP-UplinkCommon for the UL
BWP, the UE uses corresponding parameters to perform the procedures in clauses 8.1, 8.1A, and
8.3; otherwise, the UE uses corresponding parameters from rach-ConfigCommon or msgA-
ConfigCommon in BWP-UplinkCommon for the UL BWP provided by initialUplinkBWP.
  If a UE is provided initialUplinkBWP-RedCap in UplinkConfigCommonSIB and does not have
dedicated PUCCH resource configuration, the UE transmits PUCCH with HARQ-ACK
information as described in clause 9.2.1 using a PUCCH resource set provided by pucch-
ResourceCommonRedCap, except that frequency hopping for the PUCCH transmission is disabled
if intra-SlotFH is present in PUCCH-ConfigCommon. If frequency hopping of the PUCCH
transmission is disabled then, for the PUCCH transmission, the UE determines the initial cyclic
shift index in the set of initial cyclic shift indexes as r_{PUCCH} modN_{CS} and determines the PRB
index as
    -  ${RB}_{BWP}^{offset} + {RB}_{BWP}^{offset - add} + ⌊ {r}_{PUCCH} / {N}_{CS} ⌋ , i f intra - SlotFH = ‘ fromLowerEdge ’$
    -  ${N}_{BWP}^{size} - {RB}_{BWP}^{offset} - {RB}_{BWP}^{offset - add} - 1 - ⌊ {r}_{PUCCH} / {N}_{CS} ⌋ , otherwise$
  $where {RB}_{BWP}^{offset - add} is provided by additionalPRBOffset , i f provided ; otherwise {RB}_{BWP}^{offset - add} = 0.$
  If a UE is not provided initialUplinkBWP-RedCap in UplinkConfigCommonSIB and does not
have dedicated PUCCH resource configuration, the UE transmits PUCCH with HARQ-ACK
information as described in clause 9.2.1 using a PUCCH resource set provided by pucch-
Resource CommonRedCap if pucch-ResourceCommonRedCap is present or by pucch-
Resource Common if pucch-ResourceCommonRedCap is absent. For an initial DL BWP provided
by initialDownlinkBWP-RedCap in DownlinkConfigCommonSIB, if a UE in RRC_IDLE state or in
RRC_INACTIVE state monitors PDCCH according to Type1-PDCCH CSS set and does not
monitor PDCCH according to Type2-PDCCH CSS set, the UE does not expect the initial DL BWP
to include SS/PBCH blocks and the CORESET with index 0.
  For an active DL BWP not provided by BWP-DownlinkDedicated, if a UE does not indicate a
capability to operate in the active DL BWP without receiving an SS/PBCH block, the UE in
RRC_CONNECTED state assumes that the active DL BWP includes the SS/PBCH blocks that the
UE used to obtain SIB1 and, for SS/PBCH block and CORESET multiplexing pattern 1, the
CORESET with index 0.
  For an active DL BWP provided by BWP-DownlinkDedicated, unless a UE indicates a capability
to operate in the active DL BWP without receiving an SS/PBCH block, the UE in
RRC_CONNECTED state assumes that the active DL BWP includes the SS/PBCH blocks that the
UE used to obtain SIB1 or the SS/PBCH blocks provided by NonCellDefiningSSB. If the active DL
BWP includes the SS/PBCH blocks that the UE used to obtain SIB1, for SS/PBCH block and
CORESET multiplexing pattern 1, the UE expects the active DL BWP to include the CORESET
with index 0. If the active DL BWP includes the SS/PBCH blocks provided by
NonCellDefiningSSB, these SS/PBCH blocks and the SS/PBCH blocks that the UE used to obtain
SIB1 have the same QCL properties, if they have the same index.
  For a RedCap UE indicated presence of SS/PBCH blocks within an active DL BWP by
NonCellDefiningSSB, collision handling between downlink receptions or uplink transmissions and
the SS/PBCH blocks are same as described for a UE indicated presence of SS/PBCH blocks by
ssb-PositionsInBurst in SIB1 or in ServingCellConfigCommon described in all other clauses, unless
otherwise stated.
  For monitoring of a PDCCH candidate by a UE configured with NonCellDefiningSSB, if the UE
      - does not monitor PDCCH candidates in a Type0-PDCCH CSS set, and
      - at least one RE for a PDCCH candidate overlaps with at least one RE of a
    candidate SS/PBCH block corresponding to a SS/PBCH block index provided by
    NonCellDefiningSSB,
  the UE is not required to monitor the PDCCH candidate.
4.2.21.1 Definition of RedCap UE
RedCap UE is the UE with reduced capability:
  - The maximum bandwidth is 20 MHz for FR1, and is 100 MHz for FR2. UE features and
    corresponding capabilities related to UE bandwidths wider than 20 MHz in FR1 or wider
  than 100 MHz in FR2 are not supported by RedCap UEs;
  - The maximum mandatory supported DRB number is 8;
  - The mandatory supported PDCP SN length is 12 bits while 18 bits being optional;
  - The mandatory supported RLC AM SN length is 12 bits while 18 bits being optional;
  - For FR1, 1 DL MIMO layer if 1 Rx branch is supported, and 2 DL MIMO layers if 2 Rx
    branches are supported; for FR2, either 1 or 2 DL MIMO layers can be supported, while 2
    Rx branches are always supported. For FR1 and FR2, UE features and corresponding
    capabilities related to more than 2 UE Rx branches or more than 2 DL MIMO layers, as
    well as UE features and capabilities related to more than 1 UE Tx branch or more than 1 UL
    MIMO layer are not supported by RedCap UEs;
  - CA, MR-DC, DAPS, CPAC and IAB (i.e., the RedCap UE is not expected to act as IAB
node) related UE features and corresponding capabilities are not supported by RedCap UEs. All
other feature groups or components of the feature groups as captured in TR 38.822 [24] as well as
capabilities specified in this specification remain applicable for RedCap UEs same as non-RedCap
UEs, unless indicated otherwise.
supportOfRedCap-r17
Indicates that the UE is a RedCap UE with comprised of at least the following functional
components:
  - Maximum FR1 RedCap UE bandwidth is 20 MHZ;
  - Maximum FR2 RedCap UE bandwidth is 100 MHZ;
  - Support of RedCap early indication based on Msg1, MsgA (if UE indicated support of
    twoStepRACH-r16) and Msg3 for random access;
  - Separate initial UL BWP for RedCap UEs;
  - Separate initial DL BWP for RedCap UEs;
  - UE-specific RRC-configured DL BWP with CD-SSB or NCD-SSB;
  - NCD-SSB based measurements in RRC-configured DL BWP.
A RedCap UE shall set the field to supported.
```

A UE early identification method for the eRedCap UE and base station/UE operations for supporting the UE early identification method are described in detail below.

### [Method #1]

A method of identifying an eRedCap UE through a separate initial UL BWP configuration may be considered.

A base station may configure an eRedCap-specific initial UL BWP to a UE for eRedCap UE early identification. The eRedCap-specific initial UL BWP configuration may include PRACH configuration information. An eRedCap early identification function in the Msg1 stage may be supported through the configuration. The eRedCap-specific initial UL BWP configuration may be included in a system information block (SIB). For example, an eRedCap UE may be configured with the eRedCap-specific initial UL BWP to SIB1/SIB1-R/SIB1-eR, and may operate as follows if the eRedCap-specific initial UL BWP configuration includes PRACH configuration. The eRedCap UE may transmit a PRACH preamble (Msg1) in the eRedCap-specific initial UL BWP by using the PRACH configuration (i.e., included in the eRedCap-specific initial UL BWP). Through the above operation, the eRedCap UE may indicate to the base station that it is an eRedCap UE in the Msg1 stage. In other words, the base station receiving the Msg1 may identify that the UE transmitting the Msg1 is an eRedCap UE.

For example, an initial DL BWP configuration included in the SIB (e.g., SIB1), an initial UL BWP configuration, and a PRACH configuration included in the initial UL BWP configuration may be based on Table 8 below.

```
TABLE 8
- SIB1
SIB1 contains information relevant when evaluating if a UE is allowed to access a cell and defines
the scheduling of other system information. It also contains radio resource configuration information
that is common for all UEs and barring information applied to the unified access control.
    SIB1 ::= SEQUENCE {
    cellSelectionInfo SEQUENCE {
    q-RxLevMin Q-RxLevMin,
    q-RxLevMinOffset INTEGER (1..8) OPTIONAL, -- Need S
    q-RxLevMinSUL Q-RxLevMin OPTIONAL, -- Need R
    q-QualMin Q-QualMin OPTIONAL, -- Need S
    q-QualMinOffset INTEGER (1..8) OPTIONAL -- Need S
    } OPTIONAL, -- Cond Standalone
    cellAccessRelatedInfo CellAccessRelatedInfo,
    connEstFailureControl ConnEstFailureControl OPTIONAL, -- Need R
    si-SchedulingInfo SI-SchedulingInfo OPTIONAL, -- Need R
    servingCellConfigCommon ServingCellConfigCommonSIB OPTIONAL, -- Need R
    ...
    }
- ServingCellConfigCommonSIB
The IE ServingCellConfigCommonSIB is used to configure cell specific parameters of a UE's serving
cell in SIB1.
    ServingCellConfigCommonSIB ::= SEQUENCE {
    downlinkConfigCommon DownlinkConfigCommonSIB,
    uplinkConfigCommon UplinkConfigCommonSIB OPTIONAL, -- Need R
    supplementaryUplink UplinkConfigCommonSIB
    }
DownlinkConfigCommonSIB
The IE DownlinkConfigCommonSIB provides common downlink parameters of a cell.
    DownlinkConfigCommonSIB ::= SEQUENCE {
    ...,
    initialDownlinkBWP-RedCap-r17 BWP-DownlinkCommon OPTIONAL -- Need R
    }
BWP-DownlinkCommon
The IE BWP-DownlinkCommon is used to configure the common parameters of a downlink BWP.
They are “cell specific” and the network ensures the necessary alignment with corresponding
parameters of other UEs. The common parameters of the initial bandwidth part of the PCell are also
provided via system information. For all other serving cells, the network provides the common
parameters via dedicated signalling.
    BWP-DownlinkCommon ::= SEQUENCE {
    genericParameters BWP,
    pdcch-ConfigCommon SetupRelease { PDCCH-ConfigCommon } OPTIONAL, -- Need M
    pdsch-ConfigCommon SetupRelease { PDSCH-ConfigCommon } OPTIONAL, -- Need M
    ...
    }
- UplinkConfigCommonSIB
The IE UplinkConfigCommonSIB provides common uplink parameters of a cell.
    UplinkConfigCommonSIB ::= SEQUENCE {
    frequencyInfoUL FrequencyInfoUL-SIB,
    initialUplinkBWP BWP-UplinkCommon,
    timeAlignmentTimerCommon TimeAlignmentTimer
    }
    UplinkConfigCommonSIB-v1700 ::= SEQUENCE {
    initialUplinkBWP-RedCap-r17 BWP-UplinkCommon OPTIONAL -- Need R
    }
  initialUplinkBWP-RedCap
  If present, RedCap UEs use this UL BWP instead of initialUplinkBWP.
  If absent, RedCap UEs use initialUplinkBWP provided that it does not exceed the RedCap UE
  maximum bandwidth (see also clause 5.2.2.4.2).
- BWP-UplinkCommon
The IE BWP-UplinkCommon is used to configure the common parameters of an uplink BWP. They
are “cell specific” and the network ensures the necessary alignment with
corresponding parameters of other UEs. The common parameters of the initial bandwidth part of
the PCell are also provided via system information. For all other serving cells,
the network provides the common parameters via dedicated signalling.
    BWP-UplinkCommon ::= SEQUENCE {
    genericParameters BWP,
    rach-ConfigCommon SetupRelease { RACH-ConfigCommon } OPTIONAL, -- Need M
    ] ]
    }
rach-ConfigCommon
Configuration of cell specific random access parameters which the UE uses for contention based
and contention free random access as well as for contention based beam failure recovery in this
BWP. The NW configures SSB-based RA (and hence RACH-ConfigCommon) only for UL BWPs
if the linked DL BWPs (same bwp-Id as UL-BWP) are the initial DL BWPs or DL BWPs containing
the SSB associated to the initial DL BWP or for RedCap UEs DL BWPs associated with
nonCellDefiningSSB or the RedCapspecific initial
downlink BWP. The network configures rach-ConfigCommon, whenever it configures contention
free random access (for reconfiguration with sync or for beam failure recovery).
- RACH-ConfigCommon
The IE RACH-ConfigCommon is used to specify the cell specific random-access parameters.
    RACH-ConfigCommon ::= SEQUENCE {
    rach-ConfigGeneric RACH-ConfigGeneric,
    totalNumberOfRA-Preambles INTEGER (1..63) OPTIONAL, -- Need S
    ssb-perRACH-OccasionAndCB-PreamblesPerSSB CHOICE {
        oneEighth ENUMERATED
    {n4,n8,n12,n16,n20,n24,n28,n32,n36,n40,n44,n48,n52,n56,n60,n64},
    oneFourth ENUMERATED
    {n4,n8,n12,n16,n20,n24,n28,n32,n36,n40,n44,n48,n52,n56,n60,n64},
    oneHalf ENUMERATED
    {n4,n8,n12,n16,n20,n24,n28,n32,n36,n40,n44,n48,n52,n56,n60,n64},
    one ENUMERATED {n4,n8,n12,n16,n20,n24,n28,n32,n36,n40,n44,n48,n52,n56,n60,n64},
    two ENUMERATED {n4,n8,n12,n16,n20,n24,n28,n32},
    four INTEGER (1..16),
    eight INTEGER (1..8),
    sixteen INTEGER (1..4)
    } OPTIONAL, -- Need M
    groupBconfigured SEQUENCE {
    ra-Msg3SizeGroupA ENUMERATED {b56, b144, b208, b256, b282, b480, b640,
    b800, b1000, b72, spare6, spare5, spare4, spare3, spare2, spare1},
    messagePowerOffsetGroupB ENUMERATED { minusinfinity, dB0, dB5, dB8, dB10, dB12,
    dB15, dB18},
    numberOfRA-PreamblesGroupA INTEGER (1..64)
    } OPTIONAL, -- Need R
    ra-ContentionResolutionTimer ENUMERATED { sf8, sf16, sf24, sf32, sf40, sf48,
    sf56, sf64},
    rsrp-ThresholdSSB RSRP-Range OPTIONAL, -- Need R
    rsrp-ThresholdSSB-SUL RSRP-Range OPTIONAL, -- Cond SUL
    prach-RootSequenceIndex CHOICE {
    1839 INTEGER (0..837),
    1139 INTEGER (0..137)
    },
    msg1-SubcarrierSpacing SubcarrierSpacing OPTIONAL, -- Cond L139
    restrictedSetConfig ENUMERATED {unrestrictedSet, restrictedSetTypeA,
    restrictedSetTypeB},
    msg3-transformPrecoder ENUMERATED {enabled} OPTIONAL, -- Need R
    ...,
    [ [
    ra-PrioritizationForAccessIdentity-r16 SEQUENCE {
    ra-Prioritization-r16 RA-Prioritization,
    ra-PrioritizationForAI-r16 BIT STRING (SIZE (2))
    } OPTIONAL, -- Cond InitialBWP-Only
    prach-RootSequenceIndex-r16 CHOICE {
    1571 INTEGER (0..569),
    11151 INTEGER (0..1149)
    } OPTIONAL -- Need R
    ] ],
    [ [
    ra-PrioritizationForSlicing-r17 RA-PrioritizationForSlicing-r17 OPTIONAL, --
    Cond InitialBWP-Only
    featureCombinationPreamblesList-r17 SEQUENCE
    (SIZE(1..maxFeatureCombPreamblesPerRACHResource-r17)) OF
    FeatureCombinationPreambles-r17
    OPTIONAL -- Cond AdditionalRACH
    ] ]
    }
          RACH-ConfigCommon field descriptions
    featureCombinationPreamblesList
    Specifies a series of preamble partitions each associated to a combination of features and 4-
    step RA. The network does not configure this list to have more than 16 entries.
    messagePowerOffsetGroupB
    Threshold for preamble selection. Value is in dB. Value minusinfinity corresponds to −infinity.
    Value dB0 corresponds to 0 dB, dB5 corresponds to 5 dB and so on. (see TS 38.321 [3],
    clause 5.1.2)
    msg1-SubcarrierSpacing
    Subcarrier spacing of PRACH (see TS 38.211 [16], clause 5.3.2).
    Only the following values are applicable depending on the used frequency:
    FR1: 15 or 30 kHz
    FR2-1: 60 or 120 kHz
    FR2-2: 120, 480, or 960 kHz
    If absent, the UE applies the SCS as derived from the prach-ConfigurationIndex in RACH-
    ConfigGeneric (see tables Table 6.3.3.1-1, Table 6.3.3.1-2, Table 6.3.3.2-2 and Table
    6.3.3.2-3, TS 38.211 [16]). The value also applies to contention free random access (RACH-
    ConfigDedicated), to SI-request and to contention-based beam failure recovery (CB-BFR).
    But it does not apply for contention free beam failure recovery (CF-BFR) (see
    BeamFailureRecoveryConfig).
    msg3-transformPrecoder
    Enables the transform precoder for Msg3 transmission according to clause 6.1.3 of TS
    38.214 [19]. If the field is absent, the UE disables the transformer precoder (see TS 38.213
    [13], clause 8.3).
    numberOfRA-PreamblesGroupA
    The number of CB preambles per SSB in group A. This determines implicitly the number of
    CB preambles per SSB available in group B. (see TS 38.321 [3], clause 5.1.1). The setting
    should be consistent with the setting of ssb-perRACH-OccasionAndCB-PreamblesPerSSB.
    prach-RootSequenceIndex
    PRACH root sequence index (see TS 38.211 [16], clause 6.3.3.1). The value range depends
    on whether L=839 or L=139 or L=571 or L=1151. The length of the root sequence
    corresponding with the index indicated in this IE should be consistent with the one indicated
    in prach-ConfigurationIndex in the RACH-ConfigDedicated (if configured). If prach-
    RootSequenceIndex-r16 is signalled, UE shall ignore the prach-RootSequenceIndex (without
    suffix).
    For FR2-2, only the following values are applicable depending on the used subcarrier
    spacing:
    120 kHz: L=139, L=571, and L=1151
    480 kHz: L=139, and L=571
    960 kHz: L=139
    ra-ContentionResolutionTimer
    The initial value for the contention resolution timer (see TS 38.321 [3], clause 5.1.5). Value
    sf8 corresponds to 8 subframes, value sf16 corresponds to 16 subframes, and so on.
    ra-Msg3SizeGroupA
    Transport Blocks size threshold in bits below which the UE shall use a contention-based RA
    preamble of group A. (see TS 38.321 [3], clause 5.1.2).
    ra-Prioritization
    Parameters which apply for prioritized random access procedure on any UL BWP of SpCell
    for specific Access Identities (see TS 38.321 [3], clause 5.1.1a).
    ra-PrioritizationForAI
    Indicates whether the field ra-Prioritization-r16 applies for Access Identities. The first/leftmost
    bit corresponds to Access Identity 1, the next bit corresponds to Access Identity 2. Value 1
    indicates that the field ra-Prioritization-r16 applies otherwise the field does not apply (see TS
    23.501 [32]).
    ra-PrioritizationForSlicing
    Parameters which apply to configure prioritized CBRA 4-step random access type for slicing.
    rach-ConfigGeneric
    RACH parameters for both regular random access and beam failure recovery.
    restrictedSetConfig
    Configuration of an unrestricted set or one of two types of restricted sets, see TS 38.211 [16],
    clause 6.3.3.1.
    rsrp-ThresholdSSB
    UE may select the SS block and corresponding PRACH resource for path-loss estimation
    and (re)transmission based on SS blocks that satisfy the threshold (see TS 38.213 [13]).
    rsrp-ThresholdSSB-SUL
    The UE selects SUL carrier to perform random access based on this threshold (see TS
    38.321 [3], clause 5.1.1). The value applies to all the BWPs and all RACH configurations.
    ssb-perRACH-OccasionAndCB-PreamblesPerSSB
    The meaning of this field is twofold: the CHOICE conveys the information about the number
    of SSBs per RACH occasion. Value oneEighth corresponds to one SSB associated with 8
    RACH occasions, value oneFourth corresponds to one SSB associated with 4 RACH
    occasions, and so on. The ENUMERATED part indicates the number of Contention Based
    preambles per SSB. Value n4 corresponds to 4 Contention Based preambles per SSB, value
    n8 corresponds to 8 Contention Based preambles per SSB, and so on. The total number of
    CB preambles in a RACH occasion is given by CB-preambles-per-SSB * max(1, SSB-per-
    rach-occasion). See TS 38.213 [13].
    totalNumberOfRA-Preambles
    Total number of preambles used for contention based and contention free 4-step or 2-step
    random access in the RACH resources defined in RACH-ConfigCommon, excluding
    preambles used for other purposes (e.g. for SI request). If the field is absent, all 64
    preambles are available for RA. The setting should be consistent with the setting of ssb-
    perRACH-OccasionAndCB-PreamblesPerSSB, i.e. it should be a multiple of the number of
    SSBs per RACH occasion.
- RACH-ConfigGeneric
The IE RACH-ConfigGeneric is used to specify the random-access parameters both for regular
random access as well as for beam failure recovery.
    RACH-ConfigGeneric ::= SEQUENCE {
    prach-ConfigurationIndex INTEGER (0..255) ,
    msg1-FDM ENUMERATED {one, two, four, eight},
    msg1-FrequencyStart INTEGER (0..maxNrofPhysicalResourceBlocks-1) ,
    zeroCorrelationZoneConfig INTEGER(0..15),
    preambleReceivedTargetPower INTEGER (−202..−60),
    preambleTransMax ENUMERATED {n3, n4, n5, n6, n7, n8, n10, n20, n50, n100,
    n200},
    powerRampingStep ENUMERATED {dB0, dB2, dB4, dB6},
    ra-ResponseWindow ENUMERATED {sl1, sl2, sl4, sl8, sl10, sl20, sl40, sl80},
    ...,
    [ [
    prach-ConfigurationPeriodScaling-IAB-r16 ENUMERATED
    {scf1,scf2,scf4,scf8,scf16,scf32,scf64} OPTIONAL, -- Need R
    prach-ConfigurationFrameOffset-IAB-r16 INTEGER (0..63) OPTIONAL, -- Need R
    prach-ConfigurationSOffset-IAB-r16 INTEGER (0..39) OPTIONAL, -- Need R
    ra-ResponseWindow-v1610 ENUMERATED { sl60, sl160} OPTIONAL, -- Need R
    prach-ConfigurationIndex-v1610 INTEGER (256..262) OPTIONAL -- Need R
    ] ],
    [ [
    ra-ResponseWindow-v1700 ENUMERATED {sl240, sl320, sl640, sl960, sl1280, sl1920,
    sl2560} OPTIONAL -- Need R
    ] ]
    }
        msg1-FDM
        The number of PRACH transmission occasions FDMed in one time instance. (see TS
        38.211 [16], clause 6.3.3.2).
        msg1-FrequencyStart
        Offset of lowest PRACH transmission occasion in frequency domain with respective to
        PRB 0. The value is configured so that the corresponding RACH resource is entirely
        within the bandwidth of the UL BWP. (see TS 38.211 [16], clause 6.3.3.2).
        powerRampingStep
        Power ramping steps for PRACH (see TS 38.321 [3],5.1.3).
        prach-ConfigurationFrameOffset-IAB
        Frame offset for ROs defined in the baseline configuration indicated by prach-
        ConfigurationIndex and is used only by the IAB-MT. (see TS 38.211 [16], clause 6.3.3.2).
        prach-ConfigurationIndex
        PRACH configuration index. For prach-ConfigurationIndex configured under
        beamFailureRecoveryConfig, the prach-ConfigurationIndex can only correspond to the
        short preamble format, (see TS 38.211 [16], clause 6.3.3.2). If the field prach-
        ConfigurationIndex-v1610 is present, the UE shall ignore the value provided in prach-
        ConfigurationIndex (without suffix).
        prach-ConfigurationPeriodScaling-IAB
        Scaling factor to extend the periodicity of the baseline configuration indicated by prach-
        ConfigurationIndex and is used only by the IAB-MT. Value scf1 corresponds to scaling
        factor of 1 and so on. (see TS 38.211 [16], clause 6.3.3.2).
        prach-ConfigurationSOffset-IAB
        Subframe/Slot offset for ROs defined in the baseline configuration indicated by prach-
        ConfigurationIndex and is used only by the IAB-MT. (see TS 38.211 [16], clause 6.3.3.2).
        preambleReceivedTargetPower
        The target power level at the network receiver side (see TS 38.213 [13], clause 7.4, TS
        38.321 [3], clauses 5.1.2, 5.1.3). Only multiples of 2 dBm may be chosen (e.g. −202, −200,
        −198, ...).
        preambleTransMax
        Max number of RA preamble transmission performed before declaring a failure (see TS
        38.321 [3], clauses 5.1.4, 5.1.5).
        ra-ResponseWindow
        Msg2 (RAR) window length in number of slots. The network configures a value lower
        than or equal to 10 ms when Msg2 is transmitted in licensed spectrum and a value lower
        than or equal to 40 ms when Msg2 is transmitted with shared spectrum channel access
        (see TS 38.321 [3], clause 5.1.4). UE ignores the field if included in SCellConfig. If ra-
        ResponseWindow-v1610 or ra-ResponseWindow-v1700 is signalled, UE shall ignore the
        ra-ResponseWindow (without suffix). The field ra-ResponseWindow-v1700 is applicable
        to SCS 480 kHz and SCS 960 kHz.
        zeroCorrelationZoneConfig
        N-CS configuration, see Table 6.3.3.1-5 in TS 38.211 [16].
```

For example, referring to Table 8, the initial UL BWP configuration may be based on BWP-UplinkCommon (initialUplinkBWP-RedCap-r17). The PRACH configuration included in the initial UL BWP configuration may be based on RACH-ConfigCommon (and RACH-ConfigGeneric) included in the BWP-UplinkCommon. The above-described Msg1 (random access preamble) (method #1 and/or method #2) may be transmitted based on a configuration based on the RACH-ConfigCommon (and RACH-ConfigGeneric). That is, the Msg1 based on the above-described method #1 and/or method #2 may be transmitted based on a preamble related configuration and/or a RACH occasion related configuration based on Table 8.

[UE Operation when eRedCap-Specific Initial UL BWP does not Include PRACH Configuration]

It may be assumed that an eRedCap UE is configured with an eRedCap-specific initial UL BWP to SIB1/SIB1-R/SIB1-eR, and the eRedCap-specific initial UL BWP does not include PRACH configuration. In this case, the following embodiments may be considered.
A RedCap-specific initial UL BWP may be configured to SIB1/SIB1-R, and the RedCap-specific initial UL BWP may include the PRACH configuration. In this case, the following operation may be performed.

In the RedCap-specific initial UL BWP (or after switching to the RedCap-specific initial UL BWP), the eRedCap UE may transmit a PRACH preamble using the PRACH configuration of the RedCap-specific initial UL BWP. Through this, the eRedCap UE may indicate to a base station that it is a RedCap UE or an eRedCap UE in the Msg1 stage. In this case, the base station cannot distinguish whether the corresponding UE is the RedCap UE or the eRedCap UE, in the Msg1 stage. An identification of whether the UE is the RedCap UE or the eRedCap UE may be supported, if necessary, through LCID, RRC message, etc. (by base station configuration through SIB1) in the Msg3 stage.
The RedCap-specific initial UL BWP may be configured to SIB1/SIB1-R, and the RedCap-specific initial UL BWP may not include the PRACH configuration. In this case, the following operation may be performed.

In an initial UL BWP for a non-RedCap UE (or after switching to the initial UL BWP for the non-RedCap UE), the eRedCap UE may transmit Msg1 preamble. However, in this case, an early identification function of the eRedCap UE may not be supported in the Msg1 stage.

[Initial UL BWP Switching Operation when PRACH Preamble Transmission Fails]

As above, if the eRedCap UE is capable of PRACH preamble transmission in the initial UL BWP of the non-eRedCap UE, it may be assumed that a UE that starts the PRACH preamble transmission from the eRedCap-specific initial UL BWP fails PRACH transmission repeatedly/consecutively (N or more times). In this case, a switching operation of initial UL BWP may be performed. This is described in detail below.

The eRedCap UE may transmit an eRedCap PRACH preamble (for early identification) in (/switching to) an initial UL BWP including a PRACH configuration (in which the eRedCap UE is capable of the PRACH preamble transmission) among initial UL BWPs configured for the non-eRedCap UE. In this instance, if there are multiple initial UL BWPs in which the PRACH preamble transmission of the eRedCap UE is allowed, the eRedCap UE may attempt the PRACH preamble transmission as follows, starting from an initial UL BWP in which the eRedCap UE most recently attempted the PRACH preamble transmission.
The eRedCap UE may attempt the PRACH preamble transmission in the order of an eRedCap (-specific) initial UL BWP, a RedCap (-specific) initial UL BWP, and a non-RedCap initial UL BWP. Alternatively, the eRedCap UE may attempt the PRACH preamble transmission in the reverse order of the above order.
Alternatively, the eRedCap UE may select one among the initial UL BWPs, in which the PRACH preamble transmission of the eRedCap UE is allowed, for the PRACH preamble transmission. The above operation (i.e., the selected initial UL BWP) may be performed based on an implementation method of the eRedCap UE.

For the reasons mentioned above, if an initial UL BWP in which the eRedCap UE most recently transmitted (or failed to transmit, or succeeded in transmitting) the PRACH preamble is a non-eRedCap (-specific) initial UL BWP, the eRedCap UE may perform the reverse process of the above operation. In this instance, if there are multiple initial UL BWPs in which the PRACH preamble transmission of the eRedCap UE is allowed, the eRedCap UE may attempt the PRACH preamble transmission as follows, starting from an initial UL BWP in which the eRedCap UE most recently transmitted the PRACH preamble transmission.
The eRedCap UE may attempt the PRACH preamble transmission in the order of a non-RedCap initial UL BWP, a RedCap (-specific) initial UL BWP, and an eRedCap (-specific) initial UL BWP. Alternatively, the eRedCap UE may attempt the PRACH preamble transmission in the reverse order of the above order.
Alternatively, the eRedCap UE may select one among the initial UL BWPs, in which the PRACH preamble transmission of the eRedCap UE is allowed, for the PRACH preamble transmission. The above operation (i.e., the selected initial UL BWP) may be performed based on an implementation method of the eRedCap UE.

Parameter(s) for the operation based on the above-described embodiment may be configured. For example, the parameter(s) may be related to at least one of i) the number of transmissions (e.g., N), ii) an initial UL BWP in which PRACH preamble transmission is allowed, and/or iii) whether the operation of the above-described embodiment (e.g., initial UL BWP switching) is allowed for each initial UL BWP. For example, the parameter(s) may be configured via SIB1 (for each cell). For a specific example, the UE may receive SIB1 including information on the parameter(s) from the base station. For example, the parameter(s) may be pre-defined/pre-configured. For a specific example, the parameter(s) may be parameter(s) pre-defined/pre-configured between the UE and the base station.

[UE Operation when RA Procedure is Triggered in a State in which RACH Occasion (RO) Configuration is Absent in Active ULBWP]

An eRedCap UE may operate as follows.
1) If a random access procedure is triggered, and if a PRACH occasion for Msg1 preamble transmission is not configured within an active UL BWP of the eRedCap UE,
2) if an eRedCap specific initial UL BWP is configured (and if the eRedCap specific initial UL BWP includes a PRACH configuration),
3) the eRedCap UE switches to the eRedCap specific initial UL BWP and transmits a PRACH preamble.
2) Otherwise, if a RedCap specific initial UL BWP is configured (and if the RedCap specific initial UL BWP includes the PRACH configuration),
3) the eRedCap UE switches to the RedCap specific initial UL BWP and transmits the PRACH preamble.
2) Otherwise, if the eRedCap specific initial UL BWP or the RedCap specific initial UL BWP is not configured,
3) the eRedCap UE switches to an initial UL BWP for non-RedCap and transmits the PRACH preamble.

### [Method #2]

A method of identifying an eRedCap based on the following 2-step operations may be considered.

An eRedCap UE may indicate to a base station that it is an eRedCap UE using two steps (Msg1 stage and Msg3 stage), as follows.
First step: In a Msg1 transmission step, the eRedCap UE may indicate to a base station that it is an eRedCap UE or a RedCap UE using a PRACH resource shared by an eRedCap and a RedCap. In the first step, the base station may not be able to distinguish whether a UE identified based on Msg1 is an eRedCap UE or a RedCap UE. Here, the PRACH resource may be interpreted/replaced with PRACH configuration information or random access configuration. That is, because the PRACH configuration information (or random access configuration) includes information related to resources for transmission of Msg1 (e.g., random access preamble and/or RACH occasion).
Second step: In a Msg3 transmission step, the eRedCap UE may indicate to a base station that it is an eRedCap UE by using an LCID allocated for eRedCap. In other words, the eRedCap UE may transmit Msg3 based on the LCID allocated for eRedCap. The Msg3 is transmitted on an uplink shared channel (UL-SCH) which is a transport channel.

More specifically, the eRedCap UE may transmit the Msg3 based on the UL-SCH mapped to a logical channel (e.g., common control channel (CCCH)) based on the LCID allocated for eRedCap. The LCID allocated for eRedCap may be based on a definition of Table 6. The LCID allocated for eRedCap may be different from an LCID (e.g., 35, 36, 52) allocated for RedCap.

According to an embodiment, the eRedCap UE may indicate to the base stion that it is an eRedCap UE, by adding UE identification information to an RRC message transmitted on the UL-SCH using the LCID allocated for RedCap.

[Method of Selecting LCID in Msg3 PUSCH Transmission of eRedCap UE]

A RedCap UE may always use an LCID for RedCap in Msg3 PUSCH transmission regardless of whether there is an early identification in the Msg1 stage. Under the assumption, and if a 2-step eRedCap early identification method is applied, an eRedCap UE may indicate to a base station that it is an eRedCap UE using the LCID in the following method.

According to an embodiment, an LCID for eRedCap may be additionally defined. For example, among LCID values for UL-SCH defined in Table 6, some reserved value(s) may be allocated for UL-SCH of eRedCap. The eRedCap UE may use the LCID for eRedCap additionally defined above in the Msg3 PUSCH transmission. Through this, the eRedCap UE may indicate to the base station that it is an eRedCap UE in the Msg3 stage.

According to an embodiment, the eRedCap UE may share an LCID with the RedCap UE. That is, the eRedCap UE may transmit Msg3 PUSCH using the same LCID (e.g., LCID 35 or 36 in Table 6) as the RedCap UE. The eRedCap UE may indicate to the base station that it is an eRedCap UE through a RRC message included in the Msg3 PUSCH (or a RRC message transmitted based on the Msg3 PUSCH).

According to an embodiment, the eRedCap UE may transmit the Msg3 PUSCH using a LCID for non-RedCap.

According to an embodiment, assuming that the RedCap UE always uses the LCID for RedCap, the eRedCap UE may be identified as follows.

A RedCap UE (e.g., UE #1) always uses an LCID for RedCap in Msg3 PUSCH transmission regardless of whether there is an early identification in the Msg1 stage. The base station may identify the UE #1 as the RedCap UE.

An eRedCap UE (e.g., UE #2) may indicate to the base station that it is not a non-RedCap UE through the transmission of Msg1 based on the above-described first step. In this case, the base station receiving the Msg1 may not be able to distinguish whether the UE #2 is an eRedCap UE or a RedCap UE. The eRedCap UE (e.g., UE #2) may transmit Msg3 PUSCH using an LCID for non-RedCap UE. The base station receiving the Msg3 PUSCH may identify the UE #2 as the eRedCap UE.

As above, the RedCap UE can be identified by the LCID for RedCap, and the eRedCap UE can be identified by the LCID for non-RedCap UE.

If PRACH resources/configuration(s) for identification of the eRedCap UE/RedCap UE increase, a problem of insufficient PRACH resources for each UE type may occur due to excessive partitioning of the PRACH preamble. The (2-step) early identification method of the eRedCap UE based on the present embodiment may be used to solve the above-described problem.

### [2-Step Early Identification Method of Detailed UE Type]

A 2-step eRedCap early identification method may be used to distinguish a detailed UE type within eRedCap/RedCap UE types. For example, different combinations of {UE bandwidth reduction method, maximum data transfer rate reduction method} may be supported within the eRedCap UE type. The above-described 2-step eRedCap early identification method may be applied/performed as follows.

In a first step, whether a UE is the eRedCap UE may be distinguished. If the UE is the eRedCap UE, in a second step, a detailed eRedCap UE type may be distinguished.

As an example of {UE bandwidth reduction method, maximum data transfer rate reduction method} defining the detailed eRedCap UE type that is considered in terms of eRedCap UE type early identification, options according to the following Tables 9 and 10 may be considered.

The following Table 9 shows options related to the UE bandwidth reduction method.

TABLE 9
- Option BW1: Both RF and BB bandwidths are 5 MHz for UL and DL.
- Option BW2 (optionally considered for evaluations): 5 MHz BB bandwidth for
all signals and channels with 20 MHz RF bandwidth for UL and DL.
- Option BW3: 5 MHz BB bandwidth only for PDSCH (for both unicast and
broadcast) and PUSCH with 20 MHz RF bandwidth for UL and DL. The other
physical channels and signals are still allowed to use a BWP up to the 20 MHz
maximum UE RF+BB bandwidth.

The following Table 10 shows options related to a maximum data transfer rate and a reduction method of the maximum data transfer rate.

TABLE 10
4.1.2 Supported max data rate for DL/UL
For NR, the approximate data rate for a given number of aggregated carriers in a band or band
combination is computed as follows.
$data rate ( in Mbps ) = {10}^{- 6} \cdot {\sum }_{j = 1}^{J} ( {v}_{Layers}^{( j )} \cdot {Q}_{m}^{( j )} \cdot {f}^{( j )} \cdot {R}_{max} \cdot \frac{{N}_{RB}^{BW ( j ) , μ} \cdot 12}{{T}_{s}^{μ}} \cdot ( 1 - {OH}^{( j )} ) )$

wherein

```
    J is the number of aggregated component carriers in a band or band combination
    Rₘₐₓ = 948/1024
    For the j-th CC,
      ${v}_{Layers}^{( j )} is the maximum number of supported layers given by higher layer parameter$
      maxNumberMIMO-LayersPDSCH for downlink and maximum of higher layer parameters
      maxNumberMIMO-LayersCB-PUSCH and maxNumberMIMO-LayersNonCB-PUSCH for
      uplink.
      ${Q}_{m}^{( j )} is the maximum supported modulation order given by higher layer parameter$
      supportedModulationOrderDL for downlink and higher layer parameter
      supportedModulationOrderUL for uplink.
      f^{(j)} is the scaling factor given by higher layer parameter scalingFactor or scalingFactor-
      1024QAM-FR1 and can take the values 1, 0.8, 0.75, and 0.4.
  -  $Option PR 1 : Relaxation of the constraint ( {v}_{Layers}^{( j )} \cdot {Q}_{m}^{( j )} \cdot {f}^{( j )} \geq 4 ) for peak data$
    rate reduction.
    - The relaxed constraint is 1 (instead of 4).
    -  $The parameters ( {v}_{Layers}^{( 1 )} , {Q}_{m}^{( 1 )} , {f}^{1} ) can be as in Rel - 17 RedCap [ 4 ] .$
  - Option PR2: Restriction of maximum TBS for PDSCH and PUSCH.
    - For 15 kHz SCS, the maximum TBS is 10000 bits per TB and per slot.
    - For 30 kHz SCS, the maximum TBS is 5000 bits per TB and per slot.
  - Option PR3: Restriction of maximum number of PRBs for PDSCH and
    PUSCH.
    - For 15 kHz SCS, the maximum number of RBs is 25.
    - For 30 kHz SCS, the maximum number of RBs is 11.
    - The restricted number of PRBs in Option PR3 is a hardcoded limit.
```

According to an embodiment, in the first step, the eRedCap UE may indicate to a base station that it is an cRedCap UE. In the second step, the cRedCap UE may partitively indicate to the base station whether the eRedCap UE supports only Option BW3, only Option PR1, or both the Option BW3 and the Option PR1.

According to an embodiment, the UE/base station may operate as follows based on the 2-step eRedCap early identification method.

The base station may assume a specific (detailed) UE type among the identifiable (detailed) UE types from the first step. More specifically, the base station may assume a transmission frequency band of the identifiable UE from the first step. Based on the transmission frequency band, the base station may perform a subsequent operation including Msg2 PDSCH. In the second step, the eRedCap UE may transmit, to the base station, information confirming a base station assumption in the first step.

For example, in the first step, the eRedCap UE may indicate that it is an eRedCap UE or a RedCap UE. The base station may assume that it is the RedCap UE by pre-agreement/pre-definition and perform a Msg2 transmission operation. Afterwards, in the second step, the eRedCap UE may transmit/indicate to the base station that the base station assumption in the first step (i.e., the assumption where it is a RedCap UE) was wrong or (detailed) UE type information where it is an eRedCap UE. After the second step, all (detailed) eRedCap UE type information may be grasped by the base station. Or, in the above example, after the first step, the base station may assume that it is an eRedCap UE and perform a subsequent operation.

The UE detailed type or UE detailed types considered in the eRedCap UE early identification method may be defined/distinguished on at least one of UE capabilities based on the following 1) to 3).

1) A UE duplex related capability may be defined/distinguished based on the following [1] and/or [2].
[1] whether a UE supports only FD-FDD, only HD-FDD, or both in a FDD frequency band
[2] whether the UE is a UE operating in HD-FDD or a UE operating in FD-FDD in an IA process

2) An antenna/MIMO related capability may be defined/distinguished based on at least one of the following [1] to [4].
[1] Whether the UE is a UE in which the number of Rx antennas is limited to 1
[2] MIMO layer related capability (for FR2, even if there are two Rx antennas, the maximum MIMO layer may be selected from among 1 or 2. In this case, the UE may separately indicate the MIMO layer related capability.)
[3] Form factor related capability
[4] Whether it is a UE that requires additional repetition (whether the additional repetition is required from a perspective of whether it is a UE in which antenna sensitivity is reduced by a certain level (e.g. 3 dB) due to a form factor rather than the form factor itself)

3) A BW reduction option related capability may be defined/distinguished based on Option BW1/2/3 of Table 5.

The base station may perform scheduling from Msg4 stage considering the BW reduction option. For example, in the above 2-step eRedCap early identification function (method #2), in the first step, the UE may indicate/report to the base station whether to support the Option BW1. In the second step, if the UE is not a UE that supports the Option BW1, the UE may indicate/report to the base station whether to support Option BW2/BW3/PR3.

The agreement related to the method #1 and the method #2 described above is the same as Table 11 below.

TABLE 11
Agreement

| ● | A network-configurable additional separate early indication in Msg1 for Rel-18 eRedCap | |
|---|---|---|
| | UEs is supported. | |
| | ◯ | When Msg1 indication for Rel-18 eRedCap UEs is configured, it is used by Rel-18 |
| | | eRedCap UEs (with or without UE BB bandwidth reduction). |
| ● | When Msg1 indication for Rel-18 eRedCap UEs is not configured while Msg1 indication for | |
| | Rel-17 RedCap UEs is configured, Rel-18 eRedCap UEs shall share the PRACH that is | |
| | configured for Rel-17 RedCap UEs. | |
| | ◯ | Note: Rel-18 eRedCap UEs will be differentiated from Rel-17 RedCap UEs based |
| | | on Msg3 of Rel-18 eRedCap UEs. |

● Additional early indication in MsgA PRACH is not supported.

From an implementation perspective, the operations (e.g., operations based on at least one of the method #1 or the method #2) of the base station/UE according to the above-described embodiments may be processed by a device described below with reference to FIG. 7 (e.g., processors 110 and 210 of FIG. 7).

The operations (e.g., operations based on at least one of the method #1 or the method #2) of the base station/UE according to the above-described embodiments may be stored in a memory (e.g., memories 140 and 240 of FIG. 7) in the form of a command/program (e.g., instructions, executable codes) for running at least one processor (e.g., processors 110 and 210 of FIG. 7).

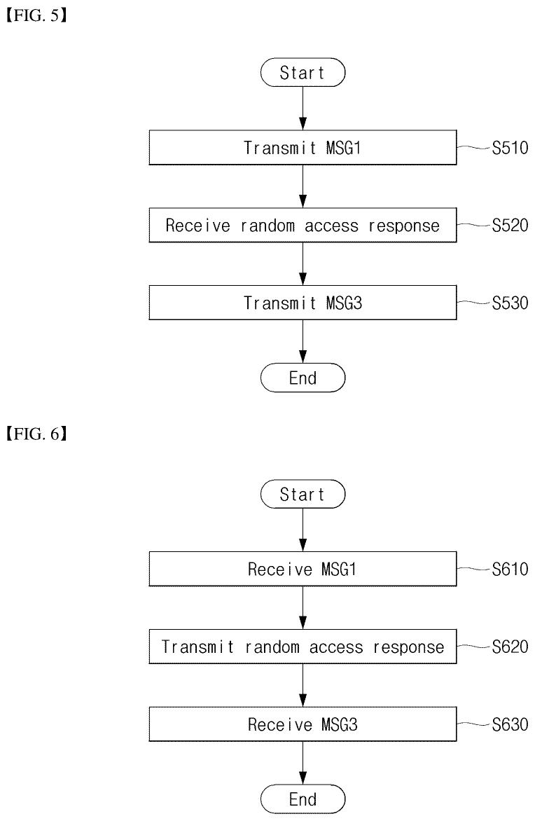

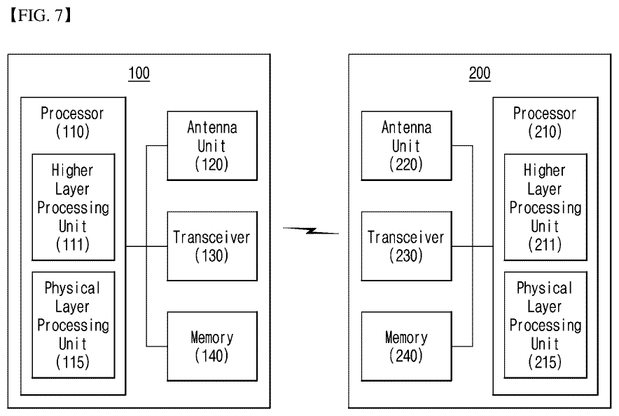

Below, the above-described embodiments are described in detail from a perspective of operations of the UE and the base station with reference to FIGS. 5 and 6. Methods described below are merely distinguished for convenience of explanation. Thus, as long as the methods are not mutually exclusive, it is obvious that partial configuration of any method can be substituted or combined with partial configuration of another method.

FIG. 5 is a flow chart illustrating a method performed by a user equipment according to an embodiment of the present disclosure.

Referring to FIG. 5, a method performed by a user equipment (UE) in a wireless communication system according to an embodiment of the present disclosure includes a MSG1 transmitting step S510, a random access response receiving step S520, and a MSG3 transmitting step S530.

In the following description, the ‘UE’ may mean the above-described eRedCap UE. For example, the UE may be a second reduced capability UE (RedCap UE) (e.g., enhanced RedCap UE introduced in Rel-18) with a different capability from a first reduced capability UE (RedCap UE) (e.g., RedCap UE of Rel-17).

In the S510, the UE transmits, to a base station, MSG1 related to a random access procedure. For example, the MSG1 may be based on a random access preamble transmitted based on a physical random access channel (PRACH). The MSG1 may be related to a 4-step random access procedure (e.g., Type-1 random access procedure).

For example, the Type-1 random access procedure may include a random access preamble transmission (Msg1) in a physical random access channel (PRACH), a random access response (RAR) reception (Msg2), a transmission of a PUSCH (Msg3) scheduled by an UL grant of the RAR, and a PDSCH (Msg4) for contention resolution. If the random access procedure is a contention-free random access (CFRA), the Msg3 transmission and Msg4 reception operations are omitted.

The MSG1 may be transmitted based on a random access configuration. For example, the random access configuration may include a configuration related to a random access preamble and/or a configuration related to a random access channel (RACH) occasion. As a specific example, the random access configuration may include configuration/information based on RACH-ConfigCommon and/or RACH-ConfigGeneric of Table 8. The RACH-ConfigCommon and/or the RACH-ConfigGeneric may be based on a configuration of an initial uplink (UL) bandwidth part (BWP).

The random access configuration is i) a first random access configuration related to the first RedCap UE or ii) a second random access configuration related to the second RedCap UE. The first random access configuration may be based on the method #2. The second random access configuration may be based on the method #1. The first random access configuration may be a first RedCap UE specific random access configuration (e.g., first RedCap UE specific random access configuration or RedCap specific random access configuration of Table 5). The second random access configuration may be a second RedCap UE specific random access configuration (e.g., second RedCap UE specific random access configuration or eRedCap specific random access configuration). For example, the second RedCap UE may be identified by the MSG1 transmitted based on the second random access configuration.

According to an embodiment, based on the transmission of the MSG1 based on the initial UL BWP consecutively failing a configured number of times, the MSG1 may be transmitted based on other initial UL BWP. The present embodiment may be based on the method #1 (initial UL BWP switching operation if PRACH preamble transmission fails). In other words, based on the transmission of the MSG1 failing (consecutively) more than a certain number of times, a switching of the initial UL BWP may be performed. The other initial UL BWP may mean an initial UL BWP after the switching.

The other initial UL BWP may be i) a first initial UL BWP for the first RedCap UE, ii) a second initial UL BWP for the second RedCap UE, or iii) a third initial UL BWP for a non-RedCap UE.

For example, the switching of the initial UL BWP may be performed in the following order: the second initial UL BWP→the first initial UL BWP→the third initial UL BWP (or reverse order).

Based on the above order, the other initial UL BWP may be determined/selected as follows.

Based on the initial UL BWP being the second initial UL BWP, the other initial UL BWP may be the first initial UL BWP.

Based on the initial UL BWP being the first initial UL BWP, the other initial UL BWP may be the third initial UL BWP.

Based on the initial UL BWP being the third initial UL BWP, the other initial UL BWP may be the second initial UL BWP.

The other initial UL BWP may be determined/selected in the reverse order of the order described above (e.g., the second initial UL BWP←the first initial UL BWP←the third initial UL BWP).

According to an embodiment, the MSG1 may be transmitted based on a random access channel (RACH) occasion (RO). The RO may be based on a configuration of an active UL BWP in which the random access procedure is triggered. The present embodiment may be based on the method #1 (UE operation when the random access (RA) procedure is triggered in a state in which RACH occasion (RO) configuration is absent within the active UL BWP).

Based on a configuration related to the RO being absent in the configuration of the active UL BWP, the active UL BWP may be changed to an initial UL BWP, and the RO may be based on a configuration of the initial UL BWP.

The initial UL BWP may be i) a first initial UL BWP for the first RedCap UE, ii) a second initial UL BWP for the second RedCap UE, or iii) a third initial UL BWP for a non-RedCap UE.

In the S520, the UE receives a random access response (RAR) from the base station. The RAR may mean MSG2 of a 4-step random access procedure. For example, the RAR may be received based on a physical downlink control channel (PDCCH) and a physical downlink shared channel (PDSCH). The RAR may be based on a transport block received on the PDSCH scheduled by the PDCCH. For example, the RAR may include an uplink (UL) grant.

In the S530, the UE transmits, to the base station, MSG3 scheduled based on the UL grant related to the RAR. For example, the MSG3 may be transmitted based on an uplink shared channel (e.g., UL-SCH). For example, the MSG3 may be transmitted based on the UL-SCH mapped to a logical channel (e.g., common control channel (CCCH)). The CCCH may be identified based on a logical channel ID (LCID).

According to an embodiment, the second RedCap UE may be identified based on the MSG1 and/or the MSG3. The present embodiment may be based on at least one of the method #1 and/or the method #2.

The MSG3 may be transmitted based on a logical channel ID (LCID) related to the second RedCap UE. The second RedCap UE may be identified by the MSG3 transmitted based on the LCID.

According to an embodiment, the LCID may be different from a dedicated LCID for the first RedCap UE (e.g., LCID 35 or 36 of Table 6). The present embodiment may be based on the method #2. The LCID may be an LCID for a non-reduced capability (non-RedCap) UE (e.g., LCID 0 or 52 of Table 6) or a dedicated LCID for the second RedCap UE.

The method may further include an SIB receiving step. In the SIB receiving step, the UE receives a system information block (SIB) from the base station. The SIB may include BWP configuration information. The BWP configuration information may be related to i) the first initial UL BWP for the first RedCap UE or ii) the second initial UL BWP for the second RedCap UE. The SIB receiving step may be performed before the step S510. For example, the SIB may be SIB1. The BWP configuration information may include an UL BWP configuration and/or a DL BWP configuration included in the SIB1. For example, the UL BWP configuration may include configuration/information based on UplinkConfigCommonSIB and BWP-UplinkCommon of Table 8. The UL BWP configuration may include a random access configuration (e.g., RACH-ConfigCommon and rach-ConfigGeneric of Table 8). For example, the DL BWP configuration may include configuration/information based on DownlinkConfigCommonSIB and BWP-DownlinkCommon.

According to an embodiment, the BWP configuration information may include i) the first random access configuration and/or ii) the second random access configuration. That is, if a random access configuration for the second RedCap UE is absent in the BWP configuration information, the following operation may be performed. The present embodiment may be based on the method #1 and the method #2.

Based on the second random access configuration being absent in the BWP configuration information:

The MSG1 may be transmitted based on the first random access configuration. The first random access configuration may be a specific random access configuration for the first RedCap UE (e.g., RedCap UE). The first random access configuration may be shared so that the second RedCap UE uses the first random access configuration. The MSG1 may be transmitted based on the first random access configuration shared by the first RedCap UE and the second RedCap UE. In this case, the base station may not be able to distinguish whether a UE transmitting the MSG1 is the first RedCap UE (e.g., RedCap UE) or the second RedCap UE (e.g., eRedCap UE). In other words, the base station may identify/assume that a UE transmitting the MSG1 is the first RedCap UE (e.g., RedCap UE) or the second RedCap UE (e.g., eRedCap UE), not a normal UE (e.g., non-RedCap UE).

Under the assumption of the base station, the following embodiment may be applied. According to an embodiment, the RAR may be received based on a maximum bandwidth supported by the first RedCap UE. The present embodiment may be based on an operation based on a type of the UE that can be identified by the base station in the first step of the method #2.

According to an embodiment, the MSG3 may be used to indicate a detailed type/capability of the second RedCap UE. Specifically, information related to a maximum bandwidth and/or a maximum data transfer rate supported by the second RedCap UE may be indicated based on the MSG3. The present embodiment may be based on an embodiment for identifying the UE detailed type in the method #2.

According to an embodiment, based on the random access configuration for the second RedCap UE being included in the BWP configuration information, the following embodiment may be applied.

Based on the BWP configuration information including the second random access configuration, the second RedCap UE may be identified by the MSG1 transmitted based on the second random access configuration. The present embodiment may be based on the method #1.

The operations based on the above-described steps S510 to S530 and the SIB receiving step may be implemented by a device of FIG. 7. For example, a UE 200 may control one or more transceivers 230 and/or one or more memories 240 to perform the operations based on the steps S510 to S530 and the SIB receiving step.

Below, the above-described embodiments are described in detail from a perspective of base station operation.

Steps S610 to S630 and a SIB transmitting step described below correspond to the steps S510 to S530 and the SIB receiving step described with reference to FIG. 5. Considering the above correspondence, redundant description is omitted. That is, the detailed description of the base station operation described below can be replaced with the description/embodiment of FIG. 5 corresponding to the base station operation. For example, the description/embodiment of the steps S510 to S530 and the SIB receiving step may be additionally applied to the base station operation of the steps S610 to S630 and the SIB transmitting step described below.

FIG. 6 is a flow chart illustrating a method performed by a base station according to another embodiment of the present disclosure.

Referring to FIG. 6, a method performed by a base station in a wireless communication system according to another embodiment of the present disclosure includes a MSG1 receiving step S610, a random access response transmitting step S620, and a MSG3 receiving step S630.

In the S610, the base station receives, from a UE, MSG1 related to a random access procedure.

In the S620, the base station transmits a random access response (RAR) to the UE.

In the S630, the base station receives, from the UE, MSG3 scheduled based on an uplink (UL) grant related to the RAR.

The method may further include an SIB transmitting step. In the SIB transmitting step, the base station transmits a system information block (SIB) to the UE. The SIB transmitting step may be performed before the S610.

The operations based on the above-described steps S610 to S630 and the SIB transmitting step may be implemented by a device of FIG. 7. For example, a base station 100 may control one or more transceivers 130 and/or one or more memories 140 to perform the operations based on the steps S610 to S630 and the SIB transmitting step.

A device to which an embodiment of the present disclosure is applicable (a device implementing the method/operation according to an embodiment of the present disclosure) is described below with reference to FIG. 7.

FIG. 7 illustrates configuration of a first device and a second device according to an embodiment of the present disclosure.

A first device 100 may include a processor 110, an antenna unit 120, a transceiver 130, and a memory 140.

The processor 110 may perform baseband-related signal processing and include a higher layer processing unit 111 and a physical layer processing unit 115. The higher layer processing unit 111 may process operations of the MAC layer, the RRC layer, or higher layers. The physical layer processing unit 115 may process the operation of the PHY layer. For example, if the first device 100 is a base station (BS) device in BS-UE communication, the physical layer processing unit 115 may perform uplink reception signal processing, downlink transmission signal processing, and the like. For example, if the first device 100 is a first UE device in inter-UE communication, the physical layer processing unit 115 may performs downlink reception signal processing, uplink transmission signal processing, sidelink transmission signal processing, and the like. The processor 110 may control the overall operation of the first device 100 in addition to performing the baseband-related signal processing.

The antenna unit 120 may include one or more physical antennas and support MIMO transmission/reception if the antenna unit 120 includes a plurality of antennas. The transceiver 130 may include a radio frequency (RF) transmitter and an RF receiver. The memory 140 may store information processed by the processor 110 and software, operating systems, and applications related to the operation of the first device 100. The memory 140 may also include components such as a buffer.

The processor 110 of the first device 100 may be configured to implement the operation of the BS in the BS-UE communication (or the operation of the first UE device in the inter-UE communication) in embodiments described in the present disclosure.

The second device 200 may include a processor 210, an antenna unit 220, a transceiver 230, and a memory 240.

The processor 210 may perform baseband-related signal processing and include a higher layer processing unit 211 and a physical layer processing unit 215. The higher layer processing unit 211 may process the operation of the MAC layer, the RRC layer, or higher layers. The physical layer processing unit 215 may process the operation of the PHY layer. For example, if the second device 200 is a UE device in BS-UE communication, the physical layer processing unit 215 may perform downlink reception signal processing, uplink transmission signal processing, and the like. For example, if the second device 200 is a second UE device in inter-UE communication, the physical layer processing unit 215 may perform downlink reception signal processing, uplink transmission signal processing, sidelink reception signal processing, and the like. The processor 210 may control the overall operation of the second device 200 in addition to performing the baseband-related signal processing.

The antenna unit 220 may include one or more physical antennas and support MIMO transmission/reception if the antenna unit 220 includes a plurality of antennas. The transceiver 230 may include an RF transmitter and an RF receiver. The memory 240 may store information processed by the processor 210 and software, operating systems, and applications related to the operation of the second device 200. The memory 240 may also include components such as a buffer.

The processor 210 of the second device 200 may be configured to implement the operation of the UE in the BS-UE communication (or the operation of the second UE device in the inter-UE communication) in embodiments described in the present disclosure.

The descriptions for the BS and the UE in the BS-UE communication (or the first UE device and the second UE device in the inter-UE communication) in the examples of the present disclosure can be equally applied to the operations of the first device 100 and the second device 200, and redundant descriptions are omitted.

The wireless communication technology implemented in the devices 100 and 200 according to the present disclosure may further include narrowband Internet of Things (NB-IoT) for low-power communication in addition to LTE, NR, and 6G. For example, the NB-IoT technology may be an example of a low power wide area network (LPWAN) technology and may be implemented in standards such as LTE Cat NB1 and/or LTE Cat NB2. The NB-IoT technology is not limited to the above-described names.

Additionally or alternatively, the wireless communication technology implemented in the devices 100 and 200 according to the present disclosure may perform communication based on LTE-M technology. For example, the LTE-M technology may be an example of the LPWAN technology, and may be called by various names such as enhanced machine type communication (eMTC). For example, the LTE-M technology may be implemented with at least one of various standards such as 1) LTE CAT 0, 2) LTE Cat M1, 3) LTE Cat M2, 4) LTE non-BL (non-Bandwidth Limited), 5) LTE-MTC, 6) LTE machine type communication, and/or 7) LTE M. The LTE-M technology is not limited to the above-mentioned names.

Additionally or alternatively, the wireless communication technology implemented in the devices 100 and 200 according to the present disclosure may include at least one of ZigBee, Bluetooth, and low power wide area network (LPWAN) in consideration of low power communication, and is not limited to the above-mentioned names. For example, the ZigBee technology may create personal area networks (PAN) related to small/low-power digital communication based on various standards such as IEEE 802.15.4, and may be called by various names.

1. A method performed by a user equipment (UE) comprising:
transmitting, to a base station, MSG1 related to a random access procedure;
receiving, from the base station, a random access response (RAR); and
transmitting, to the base station, MSG3 scheduled based on an uplink (UL) grant related to the RAR,
wherein the UE is a second reduced capability (RedCap) UE with a different capability from a first reduced capability (RedCap) UE,
wherein the second RedCap UE is identified based on the MSG1 and/or the MSG3,
wherein the MSG1 is transmitted based on a random access configuration,
wherein the random access configuration is i) a first random access configuration related to the first RedCap UE or ii) a second random access configuration related to the second RedCap UE, and
wherein the MSG3 is transmitted based on a logical channel ID (LCID) related to the second RedCap UE.

2. The method of claim 1, wherein the second RedCap UE is identified by the MSG3 transmitted based on the LCID.

3. The method of claim 1, further comprising receiving a system information block (SIB),
wherein the SIB includes bandwidth part (BWP) configuration information, and
wherein the BWP configuration information is related to i) a first initial uplink bandwidth part (UL BWP) for the first RedCap UE or ii) a second initial UL BWP for the second RedCap UE.

4. The method of claim 3, wherein the BWP configuration information includes i) the first random access configuration and/or ii) the second random access configuration.

5. The method of claim 4, wherein based on the second random access configuration being absent in the BWP configuration information, the MSG1 is transmitted based on the first random access configuration.

6. The method of claim 5, wherein the RAR is received based on a maximum bandwidth supported by the first RedCap UE.

7. The method of claim 5, wherein information related to a maximum bandwidth and/or a maximum data transfer rate supported by the second RedCap UE is indicated based on the MSG3.

8. The method of claim 4, wherein based on the BWP configuration information including the second random access configuration, the second RedCap UE is identified by the MSG1 transmitted based on the second random access configuration.

9. The method of claim 1, wherein the LCID is different from a dedicated LCID for the first RedCap UE.

10. The method of claim 9, wherein the LCID is an LCID for a non-reduced capability (non-RedCap) UE or a dedicated LCID for the second RedCap UE.

11. The method of claim 1, wherein based on a transmission of the MSG1 based on an initial uplink bandwidth part (UL BWP) consecutively failing a configured number of times, the MSG1 is transmitted based on other initial UL BWP.

12. The method of claim 11, wherein the other initial UL BWP is i) a first initial UL BWP for the first RedCap UE, ii) a second initial UL BWP for the second RedCap UE, or iii) a third initial UL BWP for a non-RedCap UE.

13. The method of claim 12, wherein based on the initial UL BWP being the second initial UL BWP, the other initial UL BWP is the first initial UL BWP.

14. The method of claim 12, wherein based on the initial UL BWP being the first initial UL BWP, the other initial UL BWP is the third initial UL BWP.

15. The method of claim 12, wherein based on the initial UL BWP being the third initial UL BWP, the other initial UL BWP is the second initial UL BWP.

16. The method of claim 1, wherein the MSG1 is transmitted based on a random access channel occasion (RO), and
wherein the RO is based on a configuration of an active UL BWP in which the random access procedure is triggered.

17. The method of claim 16, wherein based on a configuration related to the RO being absent in the configuration of the active UL BWP:
the active UL BWP is changed to an initial UL BWP, and
the RO is based on a configuration of the initial UL BWP.

18. The method of claim 17, wherein the initial UL BWP is i) a first initial UL BWP for the first RedCap UE, ii) a second initial UL BWP for the second RedCap UE, or iii) a third initial UL BWP for a non-RedCap UE.

19. A user equipment (UE) operating in a wireless communication system, the user equipment comprising:
one or more transceivers;
one or more processors; and
one or more memories operably connectable to the one or more processors and storing instructions that configure the one or more processors to perform operations based on being executed by the one or more processors,
wherein the operations comprise:
transmitting, to a base station, MSG1 related to a random access procedure;
receiving, from the base station, a random access response (RAR); and
transmitting, to the base station, MSG3 scheduled based on an uplink (UL) grant related to the RAR,
wherein the UE is a second reduced capability (RedCap) UE with a different capability from a first reduced capability (RedCap) UE,
wherein the second RedCap UE is identified based on the MSG1 and/or the MSG3,
wherein the MSG1 is transmitted based on a random access configuration,
wherein the random access configuration is i) a first random access configuration related to the first RedCap UE or ii) a second random access configuration related to the second RedCap UE, and
wherein the MSG3 is transmitted based on a logical channel ID (LCID) related to the second RedCap UE.

20.-22. (canceled)

23. A base station comprising:
one or more transceivers;
one or more processors; and
one or more memories operably connectable to the one or more processors and storing instructions that configure the one or more processors to perform operations based on being executed by the one or more processors,
wherein the operations comprise:
receiving, from a user equipment (UE), MSG1 related to a random access procedure;
transmitting, to the UE, a random access response (RAR); and
receiving, from the UE, MSG3 scheduled based on an uplink (UL) grant related to the RAR,
wherein the UE is a second reduced capability (RedCap) UE with a different capability from a first reduced capability (RedCap) UE,
wherein the second RedCap UE is identified based on the MSG1 and/or the MSG3,
wherein the MSG1 is received based on a random access configuration,
wherein the random access configuration is i) a first random access configuration related to the first RedCap UE or ii) a second random access configuration related to the second RedCap UE, and
wherein the MSG3 is received based on a logical channel ID (LCID) related to the second RedCap UE.
